(19) United States
(12) Patent Application Publication
(10) Pub. No.: US 2025/0264923 A1
(43) Pub. Date: Aug. 21, 2025

(54) SYSTEMS AND METHODS FOR MODIFYING A SMART PHONE OR TABLET DEVICE FOR HYBRID AUTOMATED SMART DEVICE USE

(71) Applicant: Visual Defence Inc., Richmond Hill (CA)

(72) Inventors: Royi TAL, Richmond Hil (CA); David CURRY, Richmond Hill (CA); Zhengsheng JIANG, Richmond Hill (CA); Vladislav MENAHEMOV, Richmond Hill (CA); Omri ARTMAN, Richmond Hill (CA); Thomas BAKONYI, Richmond Hill (CA); Roger DEO, Richmond Hill (CA); Alexandra Clarissa Marie AMOURGIS, Richmond Hill (CA)

(21) Appl. No.: 19/203,972

(22) Filed: May 9, 2025

Related U.S. Application Data
(63) Continuation-in-part of application No. 17/534,816, filed on Nov. 24, 2021, now Pat. No. 12,301,745.

(51) Int. Cl. G06F 1/26; G06F 1/20

(52) U.S. Cl. CPC G06F 1/26; G06F 1/20

(57) ABSTRACT

System and methods for adapting a smart phone or a tablet for use as a hybrid smart device able to perform different functions such as a smart camera, smart display, edge processing unit, or other hybrid functions, referred to as a modified or hybrid device. The modified device is based on a set of smart device components which has its battery removed and is instead powered by alternative circuitry. The modified device is also outfitted with a variety of modifications which allow it to operate in an extended temperature range. The modified device is loaded with software and circuitry which allow it to operate automatically without human interaction. The modified device can perform additional functions, but can also retain beneficial smart device functions and features.

### CROSS-REFERENCE TO RELATED APPLICATIONS

This present application is a continuation-in-part of U.S. patent application Ser. No. 17/534,816, filed on Nov. 24, 2021, the entire contents of which are hereby incorporated by reference herein.

### FIELD

The present invention is related to a smart phone, tablet or a similar smart device modified to perform hybrid functions as a modified system to be used for automated smart device applications.

### BACKGROUND

Smart phones (and tablets) are powerful embedded devices, which come typically with a variety of camera options, processors (such as GPUs and CPUs), multiple communication methods (such as Bluetooth, Wi-fi, cellular), location based sensors (such as GPS or GNSS), microphone, speakers, touchscreen and a variety of other sensors (such as magnetic, gyroscope, accelerometer) and other state of the art technological components and capabilities.

Smart phones are manufactured by a variety of major corporations and typically come with various options which reflect different hardware configurations at different price points. For greater clarity, the terms “smart phones” and electronic “tablets” will be used interchangeably for the purpose of describing the invention, as they can use similar components.

In many ways, smart phones and tablets are powerful computers, and as such, considering the breadth of suppliers, the wide availability, the mass production, the different hardware options, and the powerful capabilities, these devices are a popular hardware choice for a variety of computing applications which go beyond personal use cases. Today, smart phones and tablets are used for different business needs. This is typically done by loading the smart phone or tablet with a specialized software, commonly referred to as an app. Some examples of use cases include (a) smart phones/tablets used for payment processing in stores; (b) scanning QR codes and barcodes for inventory management; (c) business communications (chats, video calls and VOIP); (d) dispatching and work order management (i.e. deliveries, incident management) and many other different applications.

Smart phones and tablets may be operated by a person for a variety of applications beyond voice communications. Smart phones and tablets may be used for managing deliveries, filling in digital forms, step-by-step navigation, taxis and fares (ridership apps), or as dash-cam apps, amongst other possible applications.

Separately, Internet of Things (IoT) devices, smart cameras, kiosk devices, smart displays, edge processing units, and other similar computers can be designed with specialized chipsets to perform image or data processing for various purposes. These can include security applications, monitoring applications, surveillance applications, and/or other applications in which images or data are processed for additional insights.

Building smart devices poses unique challenges. Several processing chip manufacturers (such as Nvidia, Qualcomm, Intel, and others) offer specialized chipsets which are capable of performing specialized computations required for data processing, image processing or artificial intelligence operations. Embedded board manufacturers then typically embed those chipsets onto specialized computing boards, which are manufactured as single board computer, or as a module (for example, computer card) together with additional components such as memory, processors and microcontrollers. Those boards then have to be integrated with peripherals (such as cameras, communication interfaces, sensors), and packaged to create a smart device.

The smart devices then have to be loaded with specialized software which is compatible with all of the components used. The process may involve a complex supply-chain and extensive compatibility tests, and, as such, smart devices may not be readily available or easily designed. Many smart devices also typically lag “the state of the art” artificial intelligence capabilities available on computer video cards, smart phones or tablets.

In contrast, smart phones models (and tablets) are sold by the millions and at a consumer affordable price. These units are fully packaged as well with cameras, sensors, storage, memory, sensors and communications modules. Due to fierce competition, smart phones and tablets typically utilize state of the art components related to artificial intelligence, imaging and sensors, and newer models become available on a regular basis. When loaded with specialized software, smart phones or tablets can provide additional functionality.

Although from a computing perspective smart phones and/or tablets provide amazing capabilities at an incredible price points, the devices have their own shortcomings in relation to AI camera applications, including (a) heat issues; (b) power issues; (c) cold-start issues; and (d) operation issues.

Touching on power issues and overheating: smart phones and tablets can pack a lot of sensors and computing power into a small footprint, which creates an environment that could result in potential overheating. In addition, when smart phones or tablets perform computationally intensive processes for an extended period of time, such as (a) decoding video from the camera; (b) performing image processing and/or artificial intelligence operations; (c) utilizing internal sensors (such as position, orientation and location sensors; (d) displaying information on a screen; and/or (e) communicating wirelessly (such as via a cellular connection or WiFi™), the device is therefore drawing and using a lot of power. In addition, placing a smart phone or tablet in a warm ambient temperature, or in direct sunlight, may further heat up the device to a temperature range that may exceed its operating temperatures.

Most modern smart phones or tablets are powered by a battery (typically a lithium ion battery). Because these devices operate on battery power, the charging circuit design typically prioritizes charging the battery. As such, in many cases, the direct power source of the device is the battery. This means that the smart phone or tablet's computing circuitry may not be directly connected to the power input. Under heavy electrical load, the power draw from the battery may exceed the device's charging capacity, resulting in a voltage drop (and battery drain) over time. As the battery voltage drops down, two issues may occur: (1) the battery's charge may drop to a level which would be insufficient to power the device, resulting an unexpected shutdown; and/or (2), the device itself would draw more current in order to charge the battery. Contributing to the heating issue, the charging process also generates additional heat for the device, which may generate progressively more heat as the battery level depletes.

The smart phones and tablets may also have certain hardware and/or software measures meant to protect its electrical components. The components may include thermostat and/or temperature sensors. When the internal components reach certain temperatures, some protective measures may take place. The device may also have internal sensors which are meant to monitor temperature of certain components. For example, under heavy load, when a smart phone or tablet generates more heat than it can dissipate, and a lithium battery reaches a certain temperature, the battery may be automatically disconnected from the internal charging circuit. In that case, the device may shut down when the battery temperature reaches a critical level unless the battery temperature is reduced. The device, and/or its components, may also shutdown if the device's GPU, CPU or other critical components reach a certain temperature.

When a smart phone or tablet device is used in an untraditional manner (e.g. outdoor, or in a vehicle), it may be exposed to non-standard ambient temperatures for an extended (or indefinite) period of time. On a hot day, it can be exposed to direct sunlight. On a cold day, the temperatures can drop below a certain level (typically, 0 degrees Celsius or 32 degrees Fahrenheit), and the device may reach the same temperature. Depending on the device's battery type and hardware, certain charging functions may be disabled for safety in cold or hot temperatures. The device's holding battery charge and voltage may also be affected by temperature, as also the battery life cycle. The result is that smart phone or tablet devices may not be able to be powered on until they reach a specific operating temperature. Some batteries may also be damaged after exposure to extreme heat or cold temperatures.

The need for a person to operate the device poses many challenges. The process is error prone and the person may forget to take one of the steps which may result in the device not being in use. Due to the need to touch the smart phone or tablet each time the app is loaded, the person may also accidently change the field of view of the camera by touching the device. The person may also require specialized training to operate the device, which may pose challenge in certain work environments.

Finally, a smart phone or tablet device that is left unattended (e.g. outside) may also be stolen if it appears to be an item of value left unattended or unsecured outside.

### SUMMARY

It is understood that there are certain functions a smart phone or tablet device cannot be used for due to inherent limitations in the technology used in the smart phone or tablet device. These limitations can include hardware or software limitations which prevent operation on a permanent basis (or for an extended period of time), in an autonomous manner, and/or in varying temperature ranges. M ore specifically, smart phones or tablets can require several conditions and steps to be satisfied in order to perform such functions, which may include some or all of the following conditions: (a) the device or its parts needs to be at an appropriate operating temperature; (b) the device battery needs to be sufficiently charged for the device to boot up (if it is isn't, the device needs to be charged first); (c) the device needs to be manually powered on by a human operator by activating the power button on the phone; and/or (d) the human operator needs to select the appropriate app and launch it.

According to some aspects, there is provided a method and/or system to perform electrical and/or mechanical adaptations to a smart phone or tablets to mitigate at least one of the above presented disadvantages, which can include issues such as but not limited to: (a) heat issues; (b) power issues; (c) cold-start issues; and/or (d) operation issues.

According to some aspects, the smart phone or tablet may be transformed to a multi-purpose modified hybrid device.

One aspect provided is a hybrid system that is based on modifications to a smart phone's or tablet's electrical, mechanical, software and material composition. The hybrid smart device can then operate autonomously, and under various environmental conditions (for example, indoors or outdoors, in a vehicle or outside of a vehicle). The modified hybrid device, which can be operated as a smart camera, smart display, kiosk, smart home assistant, access control unit, smart sign or other smart device function can then autonomously operate (including potentially analyzing images using computer vision and/or artificial intelligence). The modified device can also collect data and transmit it to a remote server. The modified hybrid device may retain some of its smart phone or tablet functions.

A further aspect provided is a modified device, based on a smart phone device or a tablet device, for executing software instructions in an automated manner, the system comprising: a housing having an interior and an exterior; a set of smart device components in the interior of the housing including a smart device memory, a smart device computing processor for executing a set of instructions stored on the smart device memory and a battery compartment adapted for holding a battery, such that the battery compartment is internal to the housing; an alternative circuitry in substitution of the battery such that the battery is absent from the set of smart device components, the alternative circuitry is installed in the housing to supply operating power to the smart device motherboard instead of a battery; at least some of the space which is able to accommodate a battery holding a thermally conductive material for promoting heat dissipation; and an application as part of the set of software instructions stored in the smart device memory, the application executable by the smart device computing processor.

According to another aspect, there is provided a modified smart device system, the system comprising: a housing having an interior and an exterior; a set of smart device components in the interior of the housing including a smart device memory, a smart device computing processor for executing a set of instructions stored on the smart device memory and a battery compartment adapted for holding a battery, such that the battery compartment is internal to the housing; an alternative circuitry in substitution of the battery such that the battery is absent from the set of smart device components, the alternative circuitry installed in the housing and configured to supply operating power to the smart device motherboard instead of a battery; and a thermally conductive material at least partially filling the battery compartment to promote heat dissipation.

A further aspect provided is wherein a battery of a set of smart phone or tablet device components is absent from the interior of the housing.

A further aspect provided is a custom power circuit in a ruggedized/reinforced housing of the modified device, the custom power circuit replacing the battery by connecting at least some of the set of smart phone device components to a power supply positioned external to the ruggedized housing.

A further aspect is different enclosures in which the modified device can be enclosed in for various purposes.

A further aspect is software modifications which can provide hybrid smart device functionality, including automated launching of an operating system, applications, and specialized software, which can include artificial intelligence, image processing, and hybrid use cases.

A further aspect is a method for modifying a smart phone or tablet device into a hybrid modified device, wherein a device can be selected during or after manufacturing for modification, and in which a battery can be removed or excluded, and an alternative circuit can be applied automatically, by enabling alternative circuitry and/or by including an alternative circuitry, and wherein the device can then be augmented with inclusion of heat dissipating materials at the interior of the device's housing, and wherein the device, once closed, can also be augmented thermally externally through the passive and/or active use of material(s), attachment(s), enclosure(s) and/or fan(s), which increase thermal conductivity of the device's interior heat dissipating sources to an exterior medium. The method can also include software modifications of the device and other steps.

### BRIEF DESCRIPTION OF THE DRAWINGS

Exemplary embodiments of the invention will now be described in conjunction with the following drawings, by way of example only, in which:

FIG. 1 depicts an example of a device such as a smart phone or tablet, including its components;

FIG. 2 depicts an example of parts in the interior of a further embodiment of the device of FIG. 1;

FIG. 3 depicts different processes for removal of one or more device battery(s), using several configurations of the smart device of FIG. 1;

FIG. 4a depicts an electrical modification to the smart device(s) of FIG. 1 and/or FIG. 3 for use without one or more battery(s), the modified device including a set of smart device components;

FIG. 4b depicts external electrical attachments to the smart device of FIG. 4a for use in automated edge processing applications;

FIG. 5 depicts a sample software state diagram for automatically launching an application on the modified smart device of FIG. 4a;

FIG. 6 depicts side and back views of the modifications to the modified smart device of FIG. 4a;

FIG. 7a depicts top, side and front views of thermal-mechanical modifications for the modified device(s) of FIG. 4a and/or FIG. 6;

FIG. 7b depicts further embodiments of modifications, attachments, and/or enclosures to the modified smart device(s) of FIGS. 4a, 6 and 7a;

FIG. 7c depicts further embodiments of mechanical mounts, enclosures, modifications, and/or attachments of the modified smart device(s) of FIGS. 4a, 6, 7a and 7b;

FIG. 8 depicts sample use cases of the modified smart device(s) of FIGS. 3, 4a, 4b, 5, 6, 7a, 7b, 7c in relation to image processing and artificial intelligence;

FIG. 9 depicts a sample architecture of the modified device of FIGS. 3, 4a, 4b, 5, 6, 7a, 7b and 7c showing some typical components of the system including some of the modified smart device components; and

FIG. 10 depicts a method for modifying a smart device applying aspects of the teachings of 3, 4a, 4b, 5, 6, 7a, 7b and 7c.

### DETAILED DESCRIPTION

Embodiments of the invention can include the features of a tablet device, smart phone, or a smart camera, smart screen, and/or a series of steps and methods which allow a standard off the shelf smart phone, tablet or similar device to also operate as a and automated smart device capable of operating in a fully automated manner.

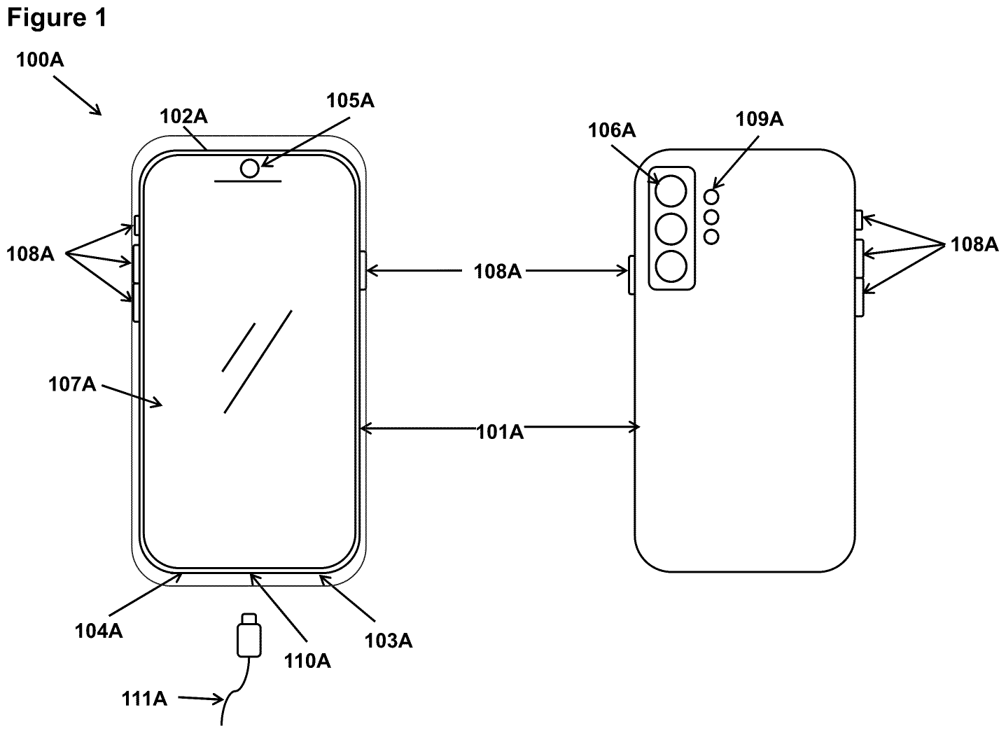

Referring to FIG. 1, an example of a smart device 101A in the form of a smart phone or tablet device is shown from the front and back. This is just an example, and by no means is meant to illustrate all of the different configurations of a smart phone, tablet, or similar devices 101A, but rather depicts what a device 101A may look like in order to further describe embodiments of the invention.

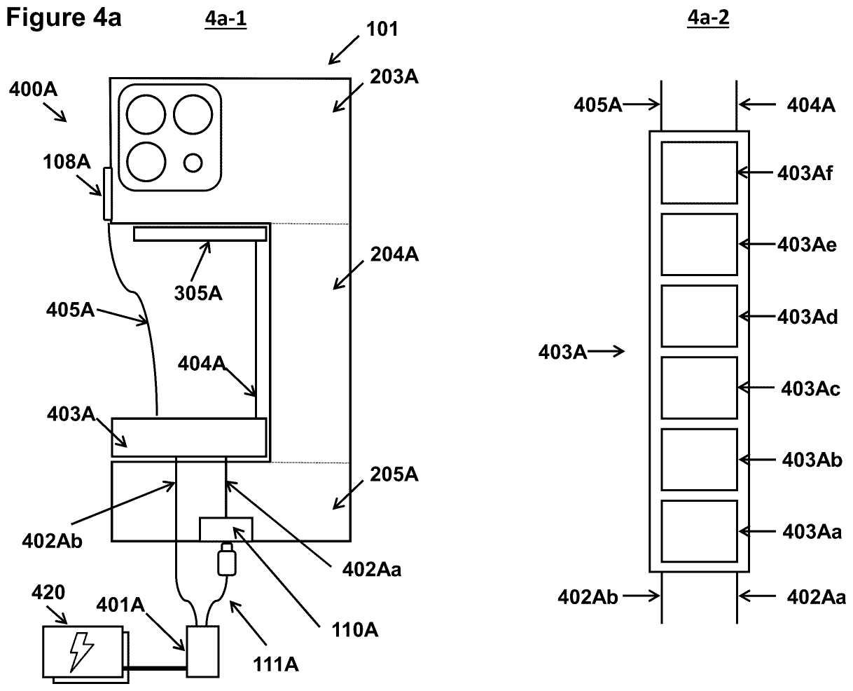

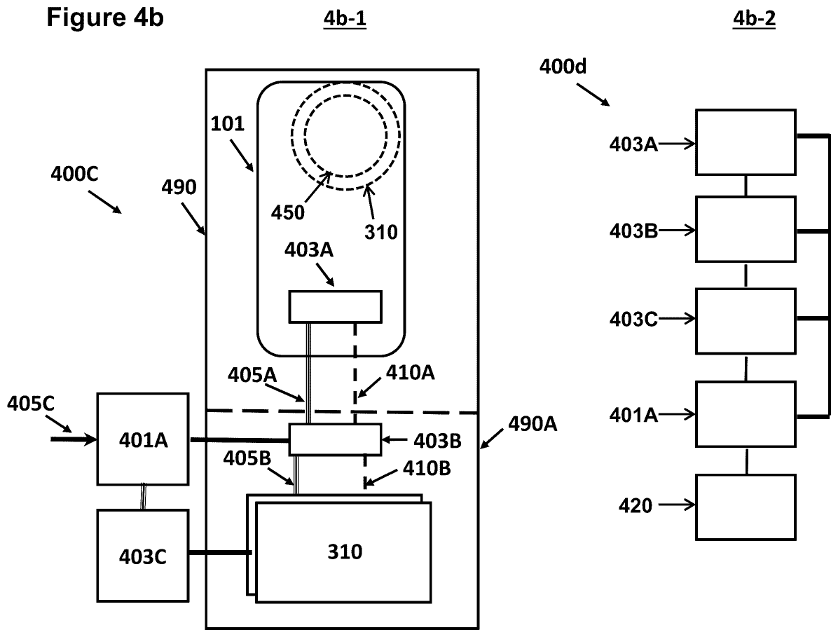

The smart device 101A may include various smart phone or tablet components, some of which will be retained in the modified device 101 (see FIGS. 4a,b) as a retained set of smart device components.

For the purpose of describing what a smart device 101A is, some components will be mentioned. The smart device 101A components can be in different locations or quantities than what is illustrated in the figures. Some may relate to the embodiments of invention and others may not. A smart device 101A may or may not include some of the mentioned components. A smart device 101A can include an earpiece speaker 102A, and it may also include loud speakers 103A. The smart device 101A can include a microphone 104A component which facilitates the smart device 101A to acquire and digitize sounds. Smart devices 101A, such as smart phones and smart tablets, can also include one or more camera(s). The cameras can be front facing camera(s) 105A or rear facing camera(s) 106A. The smart device 101A can also include on the front or the back one or more illumination component(s) 109A, such as by using a flashlight or infrared illumination. The device 101A can also include one or more buttons 108A. The smart device buttons 108A can be on the left side, the right side, the top, the bottom, the front or the back of the device 101A. The buttons 108A can be used for a variety of different functions, including: (a) powering on or off; (b) controlling the volume; (c) muting sound; (d) locking/unlocking screen rotation; (e) initiating emergency call, and other functions. The buttons 108A can be operated in different ways, related to activation duration, number of activations within a timeframe, and may be power sensing, latching, sliding, or momentary push style. The buttons 108A can be programmable or have a fixed function. The smart device 101A can also include a display 107A for displaying smart device software based information visually. The display 107A can be touch screen based facilitating the operator to control software functions displayed on the display 107A using a contact with the screen. The smart device 101A can include a charging port 110A which allows connection of the smart device 101A to a power source through a charging cable 111A with an appropriate plug head. Some smart devices 101A can also be charged wirelessly, and it may be that in the future there will be smart devices 101A which could be charged exclusively wirelessly, reducing the need for the charging port 110A. The smart devices 101A can include additional components to that provided above or exclude some of the existing components provided above, depending on the manufacturer and model of the smart device 101A. Examples of popular devices as of date of filing can include the Apple iPhone™ series, Apple iPad™ series, Samsung Galaxy™ series, Samsung Galaxy Tab™ series, Google Pixel™ series, Google Pixel Tablet™ series, Huawei Mate™ series, Huawei P™ series, Huawei MatePad™ series, Xiaomi Mi™ series, Xiaomi Redmi™ series, Xiaomi Pad™ series, OnePlus™ numbered series, OnePlus Nord™ Series, Sony Xperia™ series, and Lenovo Tab series. It is recognized that new manufacturers or existing manufacturers will launch newer series of smart phones, tablets, and similar smart devices will be launched in the future, however, the teachings of this disclosure can be applied to these future models as well.

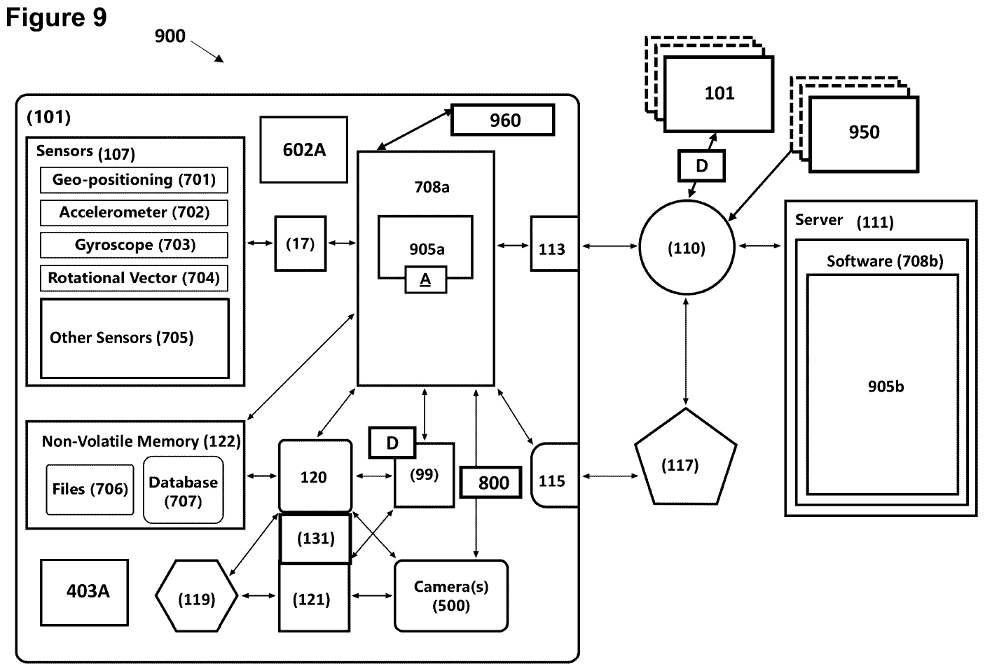

Referring to FIG. 1 and FIG. 9, the smart device 101A can utilize artificial intelligence software 905a as part of the device's software 708a. Artificial intelligence software 905a can refer to software that is capable of extracting (for example, infer, classify, segment, detect, label, predict, correlate, suggest) information from image(s), video(s), audio(s), speech, text, sensor data, and/or other data, and/or generate information (for example, as new data, metadata, derived data, generative AI output, single modal output, multi-modal output, or similar) in the form of image(s), video(s), audio(s), speech, text, and/or other data. The artificial intelligence software 905 can use one or more types of artificial intelligence software component(s), models, architectures, technologies and/or operations and related software 708a and software operations. Examples of software 708a can include, for example, operating system software, device management software, source code, app code, configuration files, databases, bios, libraries, frameworks, modules, certificates, files, data pre-processing operations, data processing operations, data post-processing operations, read operations, write operations, mathematical operations, and other software components. Example of artificial intelligence software 905a can include, for example, software used to implement multi-modal artificial intelligence, software used to implement single-modal artificial intelligence, software used to implement multi-model artificial intelligence, model files, data encoder(s), data decoder(s), transformer(s), neural network(s), network(s), layer(s), and other artificial intelligence modules. The artificial intelligence software 905a can be based on deep learning, machine learning, edge systems, cloud systems, transfer learning, algorithms, and/or other methods which can be used to adjust the way in which the artificial intelligence software can process data.

The artificial intelligence component(s) may be used, for example, for image processing, such as to detect, qualify, quantify, assess, segment, landmark, localize, classify, count, track and/or recognize one or more objects and/or conditions in images, and/or characteristics thereof. The artificial intelligence component(s) may be used, for example, for audio processing, such as to detect, classify, and/or recognize sounds, words, conditions, and/or voices in audio, and/or characteristics thereof. The artificial intelligence component(s) may be used in a multi-modal operation (in relation to input data, output data, or both), whereas, for example, the artificial intelligence receives instruction(s) and proceeds to provide the requested information, using the locally available data (such as videos, images, audio, sensor data, and/or other data) and/or context to otherwise determine, analyze, process, qualify, quantify, assess, report, alert, log, and/or generate data in human recognizable format (such as images, sounds, text) and/or in digital format, and whether for local use cases (for example, smart device communicating with people in proximity of the device visually or audibly) or for remote use cases (for example, smart device reports over a communication network and/or other compute devices to a user or a system for monitoring, surveillance, surveying, reporting, or similar).

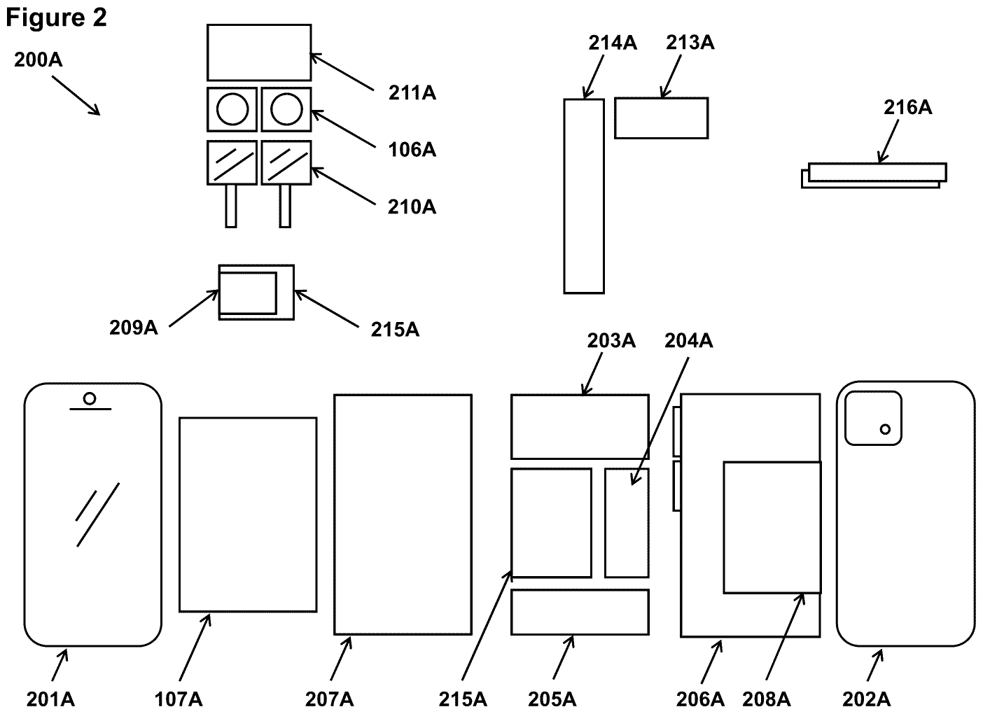

Referring to FIG. 2, we will describe by way of an example some typical components of a smart device 200A. The list itself is not comprehensive, and additional parts may present or some of the parts may be missing depending on the configuration of the smart device 101A. The embodiments of the invention themselves is not considered a smart device, but rather the results of the modifications to the smart device 101A, which are described at a later point in this description of the embodiments.

M any smart devices 101A are housed in a shell. The shell can include a front plate 201A and a backplate 202A. The shell can be ruggedized or reinforced for a more robust shell that can withstand, for example, outside temperatures, inclement weather, and/or be resistant to vandalism or tampering. The set of smart device components can also include a touch screen display 107A on the front plate 201A, the backplate 202A or both and includes a motherboard 203A. The motherboard 203A can include the computing capabilities of the smart device 101A, including the central processing unit (CPU), graphics processing units (GPU), digital signal processing unit (DSP), volatile and non-volatile memory, and other components which derive benefit from high speed interface to the motherboard 203A. Depending on the configuration of the smart device 101A, the motherboard 203A can house all of the electrical components of the device 101A or can include additional interface(s) 204A that can connect the motherboard 203A to additional daughterboard(s) 205A. For example, the smart device 101A bottom part can have a charging port 110A, speakers 103A and microphone 104A which can be housed on a daughterboard 205A, as part of the set of smart device components. Smart device 101A components can also be housed in a housing/assembly 206A or midframe 207A. For example, wireless charging interface 208A, antenna(s) 216A, earpiece speaker(s) 102A, button(s) 108A, NFC or other components can be housed within components of the smart device 101A such as assemblies or frames. Other examples of assemblies within the smart device 101A can include a Subscriber Identity Module (SIM) assembly which allows for docking a SIM card 209A and connecting it to the device's 101A modem. The smart device camera(s), for example rear camera(s) 106A, can be packaged together with their sensor(s) 210A into a camera assembly 211A which houses the cameras 106A in proximity to the motherboard 203A. An analogous camera assembly 211A can also be used for the front camera(s) 105A.

The smart device 101A can also include thermally conductive heat pipe(s) 214A, heat plates (213A), integrated conductors as part of device frame 201A, 202A and/or assemblies 206A or midframes 207A, to conduct heat away from components which generate heat, or are otherwise sensitive to heat, to areas which facilitate the heat to dissipate effectively. Smart devices 101A can also include a battery 215A. The battery 215A is typically a Lithium Ion, which allows for faster charging, holds higher power density/capacity, and provides for a longer duration before requiring additional charging. The power circuit of smart devices 101A can be used to charge the battery 215A, and the battery 215A can then be used to power the phone.

However, a battery 215A can experience failures over time in relation to heat, cold, charging cycles, and charging operations.

In view of the above, it is recognised that one of the key limitations of operating a smart device 101A in a hybrid operation (for example, also performing other functions other than those of a smart device, such as displaying advertising or information, providing smart camera functions, providing smart audio functions, and/or other edge, internet-of-things, unassisted operations), in an automated manner, and/or over a long period of time, and/or under varying environmental conditions, is the presence of the battery 215A. Batteries 215A typically also have a limited amount of charge-cycles, where charge cycle means the battery 215A is charged and then drained. Overtime, the capacity of the battery 215A to provide power to the phone diminishes. The voltage of the battery 215A can vary in different temperatures. Additionally, attempting to charge a battery at certain temperatures (for example, sub zero temperature or very hot temperature), can cause unwanted results, such as damage to the battery, which in turn can cause fire, explosion, or failure. The smart device 101A batteries 215A can also have a protective circuit that automatically protect the battery 215A from over charging and under discharging at high or low temperatures (e.g. when sensed threshold temperature is reached) which can otherwise damage the battery 215A. The automatic disconnection of the battery 215A can be done by the device software and/or hardware by: (a) completely disconnecting/switching off the battery (and effectively powering off the phone); or (b) disconnecting/switching off the charging circuit of the battery. Importantly, the battery 215A is not one of the retained sets of smart device components in the modified device 101. The smart device 101A parts can be attached to each other in various means, such as adhesives, screws, clips/pins, inserts, or compression.

In terms of modification of the smart device 105A, while the smart device 101A is open, other components or assemblies which are not relevant for the smart camera functions can be removed or be considered non-retained smart device components. For example, a wireless charging assembly, NFC assembly, or assembly with buttons which are not used can be physically removed from the device 101A. Some smart devices 101A can continue to operate after the removal of such components, while losing the function that the components provide.

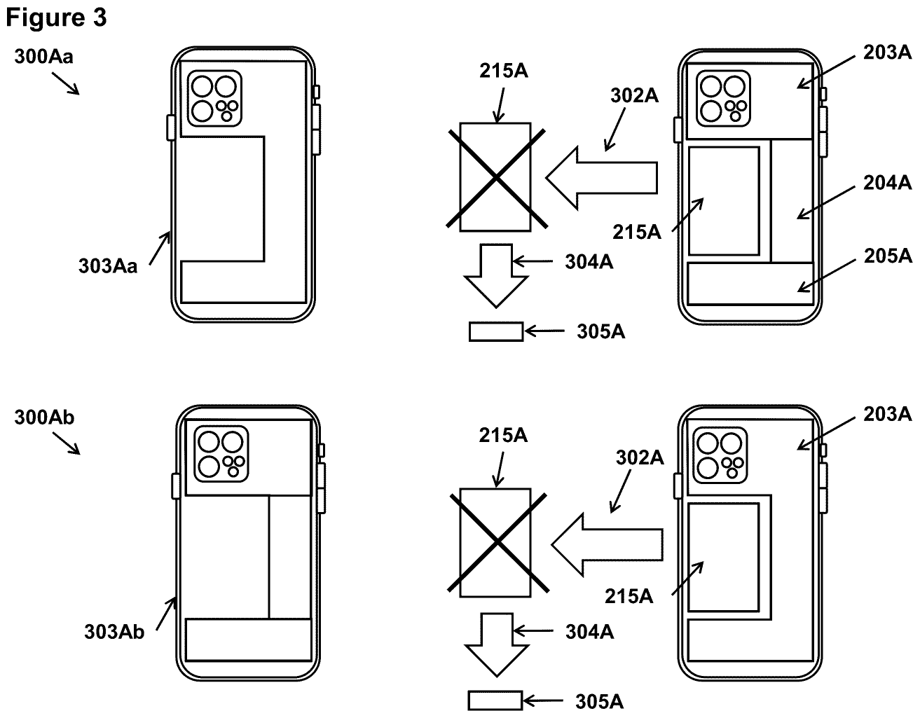

Referring to FIG. 3, there are depicted embodiments 300Aa, 300Aab of a smart device having its batteries removed. The smart device's 101A battery 215A is typically accessible by removing the backplate 202A. It can also require removal of one or more housing components/assemblies 206A. The device 101A hardware configuration can be different, and to illustrate this, two examples are provided. Example embodiment 300Aa refers to a configuration where the smart device 101A has a motherboard 203A and a daughter board 205A connected by a flex-cable interface connector 204A. Example 300Ab depicts a smart device where there is only a large motherboard 203A. In most cases, due to the battery size, the electrical components will be arranged around the battery 215A and within the shell to minimize the smart device depth/thickness. The battery 215A can be attached to the front plate 201A or a midframe/assembly 207A in various ways, such as: by adhesive, in a mounting bracket, by tape, by compression. The battery 215A would then be removed in an appropriate means, in order to make the modified device 101 (see FIG. 4a). Some examples of means to remove 302A the battery 215A include prying it out with fingers or prying tool, heating up the adhesive, peeling tape, opening screws and mounting bracket, amongst others.

The battery 215A itself can include specialized connector circuit 305A, also referred to as a specialized circuit 305A. The battery 215A charging circuit, the specialized connector circuit 305A, or the battery 215A itself can include some or all of the following components: (a) fuses; (b) chips; (c) sensors; and (d) other electrical components. Other than providing a connection interface from the battery 215A to the motherboard 203A, the specialized circuit 305A can be responsible for protecting the battery 215A from overcharging, charging in the wrong temperatures, and/or from electrical situations which can damage the battery 215A. Some smart devices 101A monitor the presence of such circuits 305A and can have sensors/software to detect that the battery circuit 305A is present for the smart device 101A to function properly. In such cases, the battery circuit 305A can be detached 304A from the battery 215A through mechanical means for use in the modified version of the smart device 101A (modified device 101—see FIG. 4a).

Once the battery 215A is removed 302A from the smart device 101A, as depicted in options 303Aa, 303Ab of FIG. 3, further methods take place to provide alternative means to power it up. The battery 215A itself can be discarded to improve the smart device's 101A performance in an automated operating environment as the modified device 101, such as, advantageously reducing power draw, reducing heat, extending operating temperature, and extending service life, among other benefits.

Referring to FIGS. 4a, 1 and 2, there are described methods and modifications 400A to power a smart device motherboard 203A without the use of a battery 215A, thereby providing the modified device 101 having retained components of the set of smart device components (e.g. motherboard 203A, cameras 105A,106A, display, antennas, network connection interfaces, etc.).

As the modified device 101 requires power, there can be different power options depending on the type of the environment. By way of example, the modified device 101 can be mounted to a human, vehicle, building, wall, pole, post, ceiling, tree, gantry, helmet, drone, robot, platform, tripod, traffic light, tower, streetlamp, gate, elevator, window, windshield, vessel, aerial vehicle or any other surface which allows the modified smartphone device 101 to be securely attached thereto. It is recognized that the available power sources 420 at the installation location can include AC or DC power sources at different voltage levels, at different amperages, whether permanent or battery powered, stable or unstable. It is recognized that the power sources 420 can vary. For example, the power sources can be regular electricity, battery electricity, Power over Ethernet, solar power, rechargeable battery, vehicle battery, power bank, or other power sources.

While the power source 420 configurations can vary between location to location, or environment to environment there would typically be a power supply 401A which would provide power to the modified device 101 at required voltage(s), amperage, and wattage. For example, the modified smart device 101 can receive power from the charging port 110, which may be a USB port (or variation thereof, for example, a USB-C port), or a cable connected to the power supply 401A that provides the appropriate voltage and amperage for the modified device 101.

Referring to FIGS. 4a, 4b, 1 and 2, it is recognized that in some embodiments, the charging port 110A, which may be a USB connection such as a Type-C in modern smartphones, can connect through an external circuit 403B that may comprise one or more of a USB hub, USB splitter, or USB Converter/adapter (for example, to Power over Ethernet, Serial over USB, or other interface adapter) to one or more external component(s), device(s), attachment(s), modules, add-ons, and/or peripherals, and/or combinations thereof. These additional components can include, for example, additional sensors (for example, LIDAR, infrared, acoustic, motion, vibration, GNSS, GPS, laser, temperature, chemical, particles), additional data storage, additional camera(s) (for example, pan tilt zoom, fish eye, long range, fixed, thermal, 360, day/night, or other cameras) additional illumination component(s) (for example, infrared, white, laser, LED, bulb, narrow, regular, wide), additional cooling (for example, fans), additional microphone component(s) (for example, singular, multi, arrays, directional, omni directional), additional speaker(s), additional receiving and transmitting communication module(s) (for example, modems and/or antennas), electrical input circuitry (for example, dry contacts, electrical contacts, etc.), electrical output circuitry (for example, digital outputs, relays, etc.) or motorized actuators for panning the device 101 and/or camera assembly 490. It is recognized that the modified device 101, and optional power, data and external circuit 403B (e.g., communication hubs), and optional peripherals can be powered by one or more power supplies 401A, and that additional power distribution circuitry 403C and/or power supplies 401A can be required, for example, to the peripherals, hubs (not shown), or device (not shown). Where the external circuit 403B comprise one or more hubs, this demonstrates that in some embodiments, it can be possible to split power and communication 410 to the device, and/or possible to split power 405B and communications to 410 to the peripheral(s) 310.

Many electronics computing devices (including smart devices 101A-see FIG. 1) can require a higher input current (over that of normal operational current) when powering on. This is typically called in-rush current, startup/switch-on current, or input surge current. When the battery 215A is present, the battery 215A can supply the in-rush current. However, without the presence of the battery 215A in the modified device 101, some retained smart device circuitry could require that the power supply 401A also provide for enhanced current flow capabilities such as quick charge, which allow for a higher throughput of electrical current, facilitating the modified device 101 to boot successfully. In respect of an external circuit 403B such as a USB hub or a power supply 401A, in some embodiments those can require also signaling components that allow the device's 101 charging point 110A, which may comprise integrated USB circuitry, to activate enhanced power functions.

The charging port 110A on the smart device 101A can be present on the motherboard 203A or a specialized daughter board 205A connected by an interface 204A. For the purposes of describing the modifications, we will refer to the combination of motherboard 203A, and optional interface 204A and optional daughterboard 205A collectively as motherboard 203A as retained in the set of smart device components.

The charging port 110A of the modified device 101 can be connected to a power supply 401A (e.g., a charger) through a connector cable 111A which can be embodied as a USB-C cable, or future variation thereof, but can also have other variations, whether USB or not USB (it is likely that with time, the interfaces for charging cables 111A change with further innovations in power and interface cables). The charging port 110A can sense power is connected to the modified device 101, and initiate booting of at least some of the device 101 components.

The charging port 110A can also be connected to a smart power supply 401A, external circuit 403B (e.g., a USB hub), which can detect when an external circuit allows the device 101 to power on autonomously (when power is provided) and can include additional functions such as scheduled, remote start and shut down, or start/shut down, which can be triggered by one or more sensor(s) and/or condition(s). For example, in embodiments where the power source 420 provides solar power or battery power, the customized external circuit 403B can provide power to the device 101 once certain conditions are met, for example time of day, day of the week, power sensor triggering, voltage sensor triggering, motion sensor 310 triggering, vibration sensor 310 triggering, intrusion sensor 310 triggering, or any other condition which is met (for example, electrically, mechanically, environmentally, and/or combinations thereof). Similarly, in some embodiments, the external circuits can power down the device when certain conditions are met (for example, time of day, day of week, power sensor, voltage sensor, environmental sensor, or other sensor(s) or condition(s) which cause the external circuit 403B to power the device 101 off).

For the purposes of using the modified device 101 (for example, a smart phone reconfigured to operate as a smart camera 101, or a tablet reconfigured to act as digital bus stop signage 101), the DC power pair 402Aa from a power socket such as the charging port 110A can be jumped (for example using soldering and electrically conductive cables 402Aa) onto an electrical connection circuit 403A (also referred to as custom power circuit 403A). The power supply 401A can also provide for a direct DC power pair cable 402Ab (also referred to as an electrical connection 402Ab) which could be connected into the internal electrical connection circuit 403A. While the power circuit 403A in many cases could be placed internally to the modified device 101 to conserve space, in some variations it can be placed outside of the modified device's 101 enclosure 700A. The power circuit can allow in various embodiments for autonomous start/stop of the device, remote start/stop of the device and/or scheduled start/stop of the device. Based on providing power via the power circuit 403A, without an internal device battery, the device can have a scheduled start without concern for the battery being charged.

In some embodiments, the custom power circuit 403A can take as input power from the power supply 401A using direct power connections 402Ab or jumped power 402Aa through an existing power plug such as the charging port 110A. FIG. 4a shows each of these options, recognizing that either one or both of the options of connections 402Ab, 402Aa can be used in the modified device 101, as desired. In some embodiments the alternative power connection 402Ab can enter onto the smart device 101 through alternatives to the existing charging port 110A. For example, through an alternative backplate 202A component, through a hole drilled in a backplate 202, through a hole drilled onto a frame or midframe 207A, through a hole made by removing an assembly 211, through a removal or replacement of a button 108A, or any other options in which a gap or a hole on the modified smart device 101 exterior, or its exterior facing components, is made or accommodated to allow the alternative power connection 402Aa into the interior of the device 101.

The custom electrical power circuit 403A (see FIGS. 4a and 4b, sections 4-1 and 4-2 include one or more components selected from one, some or all of the following additional components to that of the retained set of smart device components:
(a) Electrical safety component(s) 403Aa such as a fuse or surge protection circuit that operates to provide overcurrent protection circuit for the circuit 403A. The fuse can be Positive Temperature Coefficient (PTC);
(b) Voltage regulation component(s) 403Ab, (for example, Transient Voltage Suppressor (TVS)) to inhibit from voltage fluctuations, and stabilize the input voltage when the input voltage raised above its safe operating voltage level to facilitate a safe booting (as the device 101A can be expecting a battery 215A within a certain voltage level). The voltage regulation component(s) 403Ab can be a clamping device that chants the excess current when it detects over voltages to protect the system circuits. The voltage regulation circuit can be located as part of the specialized circuit 403A or as part of a second external power circuit 403B that is attached directly to a power supply 401A.
(c) Capacitance component(s) 403Ac such as an electrolytic capacitor and/or ultra capacitor, to store energy, to regulate output voltage, to filter the input or output transient voltage, and/or facilitate the modified device 101 to shut down appropriately when the power supply 401A (or power 405C to the power supply) is disconnected;
(d) Reverse current and reverse polarity protection component(s) 403Ad, such as a fast-switching diode;
(e) Component(s) of the temperature control circuit 403Ae, such as a thermostat, thermal fuse, or thermal switch, that facilitate the device 101 to only power on within a specified temperature range; and/or to shutdown the device 101 when it is at high temperature. The temperature control circuit 403Ae can, in some embodiments, also monitor the temperature of the device and can initiate either heating or cooling elements such as heaters or fans;
(f) Microcontroller circuit 403Af to send power (on or off) signal via wire 405A to the device 101A based on availability of power. The microcontroller can also be used for LED and fan control; and/or
(g) Inductance circuit 403Ag components to limit in-rush current to protect the device 101A circuitry or regulate its current.

The specialized power circuit 403A components shown individually in FIG. 4a can be inter-connected through a printed circuit board, cables, heat shrink tubing, conduits, soldering, surface mounting and/or other common methods of connecting components of an electrical circuit.

The specialized circuit 403A can be connected to the battery connector 305A component using a DC pair of wires 404A, or an extended printed circuit board (PCB) 404A. The connection to the power supply 401A to the motherboard 203A could be done directly (using a direct connection 404A—not shown) or through the battery connector 305A as shown by example. When powered, the specialized circuit 403A then provides the appropriate levels of voltage and current that meet the appropriate logic for the motherboard 203A now used by the modified device 101 to power on and boot the modified device 101. It can also be that the specialized circuit 403A simulates a battery voltage level, temperature, or state through a connection (not shown, but can be part of the battery connector 305a), which provides the appropriate logical conditions for the modified device 101 to power on successfully.

The power source 420 can be from a variety of sources such as from electrical mains, from battery sources, capacitors, solar panels, battery charging circuits, transformers, power distribution panels, turbines, or other power sources. When the power source 420 is transient there can be additional circuits (for example, power supply 401A, power distribution circuitry 403C, external circuit 403B, internal circuitry 403A, or a combination thereof) that are able to deliver power in a scheduled manner or when a specific criterion has been met. In some instances, the power source 420 can provide the appropriate voltage, wattage and amperage directly. In others, a power supply 401A can be required. The power supply 401A can provide step down power, step up power, or a combination thereof. It is recognized that in some instances the power sources 420 and power supply 401A can be integrated; for example, a backup battery power source 420 may be integrated to the power supply 401A.

For example, in the case of rechargeable batteries being used, it can be that the delivery of power begins when a certain amount of power has been stored by the battery. Another example is a switching power supply 401A with a power source 420 in the form of a battery charging circuit which powers the device 101 directly from a battery when a primary power source 420 is not available. The power supply 401A can also be integrated to additional circuits, computing and/or sensors (not shown) which can, for example, power on or off the device 101 based on specified conditions such as schedule (day, time, date), sensor activation (ignition, motion, vibration or other), temperature, precipitation (such as rain or snow), type of available power source (grid power or other source), or other criteria, or a combination thereof.

It is recognized that generally, the one or more power supplies 401A and external circuit 403B, which may supply power as a USB hub, for example, can each perform such functions in relation to downstream power circuits. For example, the main power supply 401A can perform these functions directly for the device's 101 custom circuit 403A, or alternatively, a USB hub (if present) can perform such functions in relation to the output power that is provided to the custom circuit 403A. Finally, the custom circuit 403A itself can provide such functions in relation to the modified device's 101 internal components. These operations can be carried out as part of specialised circuit 403A and/or as part of an external circuit 403B. If external, the external circuit 403B can include additional ports to deliver power to peripherals 310 or to receive information from peripherals 310. It is recognized that if an external circuit 403B in the form of an external power module is used (external to the modified smart device 101), the external circuit 403B can deliver one or more required voltage(s) (for example, 3V, 5V, or 12V) through original charging ports 110A, or custom made power ports (such as those that receive the power pair cable 402Ab) wired into the modified device 101. The external voltage power module can for example have different power outputs for different system components. For example, the module may deliver power at selected voltages to one or more devices such as modified device 101 and a peripheral 310.

With reference to FIG. 2 and FIG. 4b, the system assembly (i.e. modified device 101 plus peripherals) housing 490 can optionally contain other peripherals 310 such as illumination components, diodes or bulbs. These can be directly integrated onto an external enclosure attached to the device 101 (not shown), or as separately attached peripherals 310. The illumination can be done in the visible spectrum, infrared spectrum and/or combination thereof. The additional lighting can be in addition to the illumination components 109A that is common in smart devices 101A such as smart phones or tablets. The lighting can be powered independently or through a connection with the device 101.

This camera assembly 211A can include further attachment(s) 450, which are typically external to the smart device's backplate 202A or front plate 201A that are mounted within, as part of, or externally (not shown) to the housing 490, 490A. These attachments can include, for example, lens(es) (whether fixed, vari-focal, or motorized), polarizing lens, color filters, or other optical enhancements 450 that are crafted to fit over the integrated camera assembly 211A and rendered immovable. Focussing can be done through manual methods on initial setup or using a motorized lens assembly, or automated with the aid of a range finder and optical zoom. Lenses can also be used interchangeably either mechanically to manually or mounted as part of the same external housing 490, 490A. These lenses can, for example, improve the night vision capabilities of device 101 by concentrating more light for the camera assembly's 211A sensor. Coatings, filters or specialized lenses can also be used to improve visibility and prevent distortion of images under dynamic environmental conditions. Polarizing lens and/or filters can block certain light wavelengths, resulting in more scene optimized images. It is recognized that in some embodiments the peripheral 310 in the form of an optional lighting attachment and optional optics attachment 450 can be integrated as one attachment.

Referring to FIG. 4b, there is shown external power embodiments 400c, 400d to power the modified device 101. The modified device 101 can be powered by an external circuit (see 4b-1, 4b-2). The external circuit 403B can have one or more types of connections for input and output. Input power connections 405B can include standard plugs or connectors which are compatible with the specific electrical standard (plug, voltage, amperage and wiring). Input power connectors can include one or more of different power connector types, for example AC power connectors, DC Power Connectors, NEMA Connectors, IEC Connectors, USB connectors, loose wire connectors, sockets, terminal blocks, custom connectors or other connection modules applicable to supplying power to electronics. The external circuit 403B can contain one or more output ports or equivalent connector cable(s) that delivers the appropriate voltage/power/amperage 405A, 405B, data 410A, 410B, or combination thereof. The external circuit 403B can reside in the same housing 490 as the device 101, or in a separate one or more housing(s) 490A which are attached to the modified device housing 490A.

Smart device 101A can boot into an initial state in which the device is locked and/or in a power-saving mode. Depending on the smart device manufacturer, operating system, the application permission requirements and security settings, launching using third party software (apps and/or services) can, in some cases, require the device to be activated or turned on by a user by pushing a button 108A, allowing the launch of the third party software (such as the app or service).

Accordingly, in the modified device 101, the power circuit 403A can have a wire 405A (e.g., a single wire or double wire cable) to connect directly to the power button 108A switch in order to simulate a user pushing the button and “turning on” the phone. The power-on wire 405A can replace the button contact, or be connected to the same electrical contact interface, through soldering (by way of example as to how it could connect). As such, it is recognised that the power-on wire 405A is used by the custom power circuit 403A to simulate the user pushing the button 108A and thus “turning on” the modified device 101. In other words, the power-on wire 405A coupled between the custom circuit 403A and the button 108A is used by the modified device 101 to bypass any need to manually push the button 108A in order to start the modified device 101, as further discussed below. It is recognized that in some embodiments (not shown), the button actuation can take place through an external representation of the externa power circuit 403A, or through a separate external power circuit 403B.

The modified smart device 101 can be powered by a power source 420, connected to a power supply 401A (for example, quick charge adapter), which is connected by electrical connections 402Aa 402Ab (e.g., wires or traces) to the modified device's 101 battery replacement circuitry 403A. However, more complex power structure can also be applicable in different embodiments. For example, the main power source 420 can be connected to a power supply 401A directly to an additional (but external) power circuit 403B and/or to one or more power distribution circuitry 403C. It is recognized other embodiments can also distribute the power directly or through the external circuit 403B (e.g., hubs) to the device 101 and/or peripherals 310. It is further recognized that the functions of the different power supplies/circuitry 401A, 403C, 403B, 403A can overlap, provide redundancy, or can be distributed, and that the modules can be connected in parallel, in series, be combined, can be split, or otherwise be fine-tuned to the operational requirements of that particular configuration for the environment in which the modified device is intended to operate.

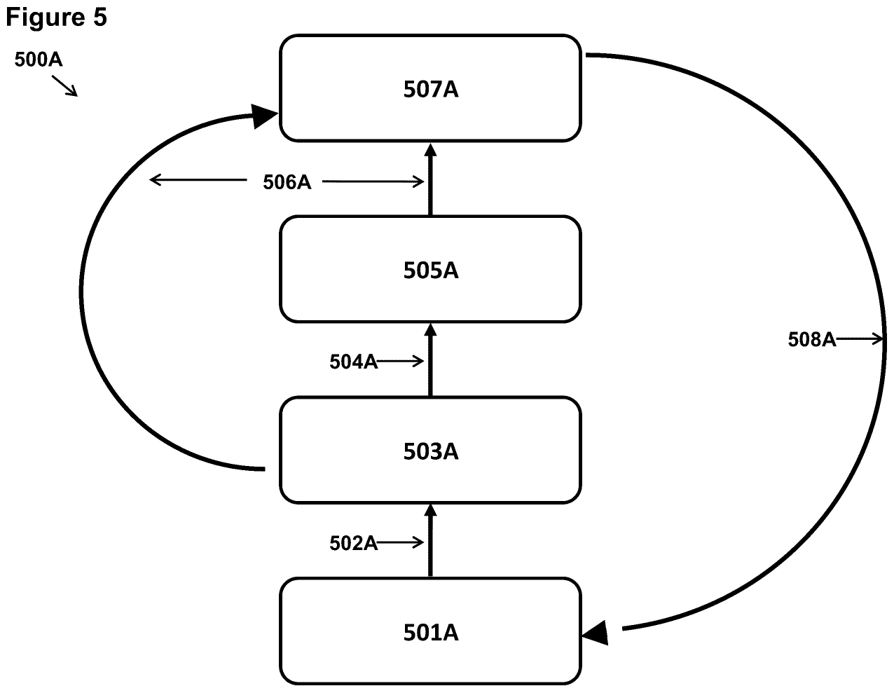

Referring to FIG. 5, there is shown a sample software state diagram 500A (for a smart camera application A, also referred to as an application A) stored on one or more of the memory(s) 99 of the modified device 101 that shows by way of example, different states that the modified device 101 system can have.

Starting from an initial state where the modified device 101 is powered off, the modified device 101 starts in a powered-off state 501A. When the modified device 101 is connected to a power source 502A, the special power circuit 403A can provide the appropriate electrical conditions (for example, voltage, current, push button actuation, and/or other conditions) for the modified device 101 motherboard 203A to initiate a boot sequence whereas the modified device 101 state is then booted/running 503A using the software A. It is noted that the power can be automatically supplied via wire 405A by the special power circuit 403A directly to the button 108A simulates pressing of the button 108A.

In some cases, once the device 101 is booted 503A, the application software A (resident in the memory 99 as a set of instructions for execution by the computer processor 120) can automatically launch 507A as a scheduled operating system (OS) task 506A or automated app launch 506A. The smart device software A can launch 507A directly or through an intermediate software such as a Mobile Device Management (MDM) system stored in the memory 99. Some MDM platforms provide a function where the MDM software is launched 507A, and can then launch 507A other applications in automatically. In some embodiments, the Mobile Device Management software can even be part of the operating system of the smart device.

Some operating systems of a smart device 101A, security permissions and mobile device manufacturers prevent access to the devices 101A camera(s) when the device 101A is in booted mode 503A, and the device 101A would have to be manually activated 504A by a user.

In order to compensate for the above prevented access in the modified device 101, power button press 504A could be simulated (as discussed above) by the specialized circuit 403A which then transitions the modified device 101 state to an activated/unlocked 505A state, for example via operation of the application A. From the open state 505A, the software 708a used to implement an app/service can then be launched 507A automatically in a direct manner 506A such as an OS task or an indirect manner 507A through another app (for example, through MDM software).

The modified device's 101 operating software A can also be switched, adapted, utilize custom settings, or be rooted in order to enable automated start features (503A, 504A, 505A, 506A, 507A or a combination thereof) in the operating system of the motherboard 203A or the application A. Rooting is a process where certain security features in an operating system are bypassed or disabled in order to more freely program the modified device 101 to undertake functions which would otherwise be prevented by the original smart device device's 101A programming. It is recognised that at least one or more of the smart device operating software A, application software 708a, and/or artificial intelligence software 905a can be additional to the retained set of smart device components.

Referring again to FIG. 5, once the smart device application software 708a of the modified device 101 is launched 507A, the resulting app can run indefinitely so long as the device 101 is programmed to do so (for example, by turning off screen saver or auto device lock features of the modified device 101 operating system features resident in the memory 99).

The modified device 101 can be shut off 508A in a variety of ways, including for example: (a) by disconnecting the modified device 101 from the power supply 401A (for example, by switching off the power source); (b) by disconnecting the power cable 111A to connecting the device 101 to the power supply 401A; (c) programmatically, by sensing a power-off request from an external circuit 403B, a peripheral, a local input from a vehicle, power source, or a button; (d) by meeting a software condition in the modified device's 101 software A; and/or (e) by sending a power off instruction which is communicating to the modified device to power off over a communication network.

As such, the modified device's 101 software 708a (which comprises AI models A and AI software 905a) can accommodate cooperation with a device operating system A stored in the memory, such that rooting is employed and the device operating system is programmed to launch from the software 708a one or more applications automatically when the retained set of smart device components are booted, such that powering on the set of smart device components is performed by bypassing use of a power button of the retained set of smart device components.

Further, the custom power circuit 403A, 403B can reside outside of the smart device 101 original housing (see FIG. 4b, 7b by example), such that the custom power circuit 403b is external to the retained set of smart device components (of the smart device 101A). For example, a fan 704b can be powered and controlled by the custom power circuit 403A. For example, the application can be launched automatically through an OS setting upon a device boot 503A of the retained set of smart device components. For example, the application is launched automatically when the modified device 101 is switched from a booted 503A state to an unlocked state 505A. For example, the application is launched through a third party mobile device management application, A stored in the memory 99. For example, the custom power circuit 403A holds a charge for the retained set of smart device components to shut down without power interruption when an external power supply 401A is disconnected from the retained set of smart device components.

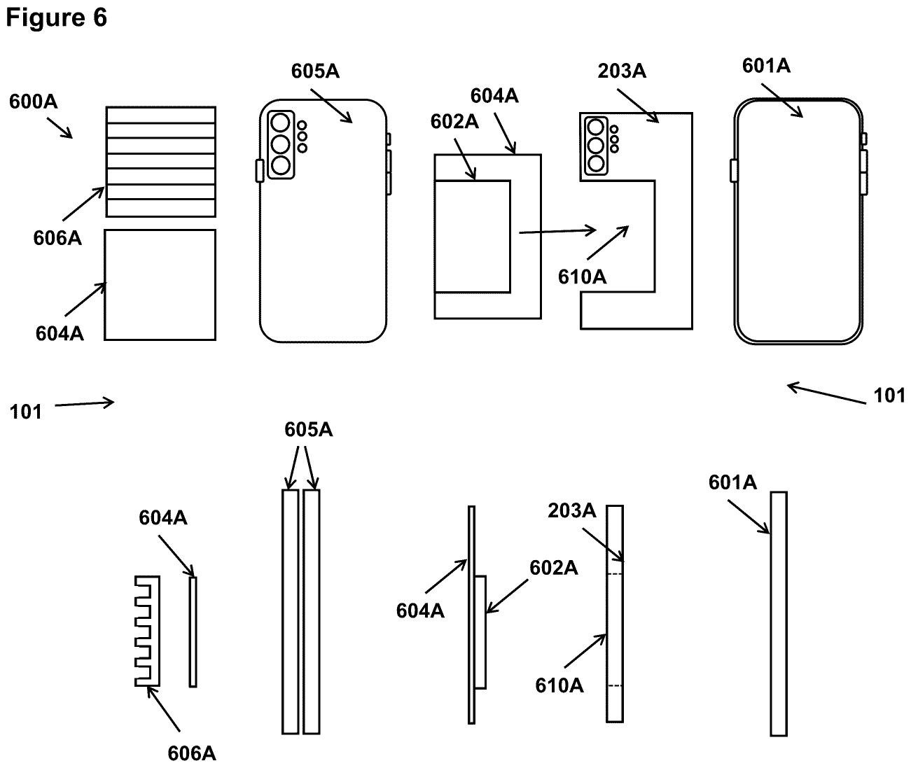

Referring to FIG. 6, we depict, by way of example, thermal and mechanical modifications 600A to a smart device 101A (see FIGS. 1, 2) which help the resulting modified device 101 to dissipate heat better (in view of the removal of the battery 215A and other desired operating conditions of the modified device 101 (e.g. onboard AI processing of the acquired images via the camera(s) 105A, 106A, generative AI functions, continuous video recording, continuous ad display, and/or other processing functions which can generate heat).

Referring to FIG. 6, the modified device 101 can have a front plate 601A (which can include a screen and optional frames/assemblies) and a backplate 605A. There can be a midframe as well as discussed in FIG. 2. Since the battery 215A (see FIG. 3a) can be typically accessed from the back, for the purposes of this diagram we will treat the front plate 601A as the component where the motherboard 203A is housed. The motherboard 203A can be a standalone motherboard 203A or several electronic printed circuit boards connected together.

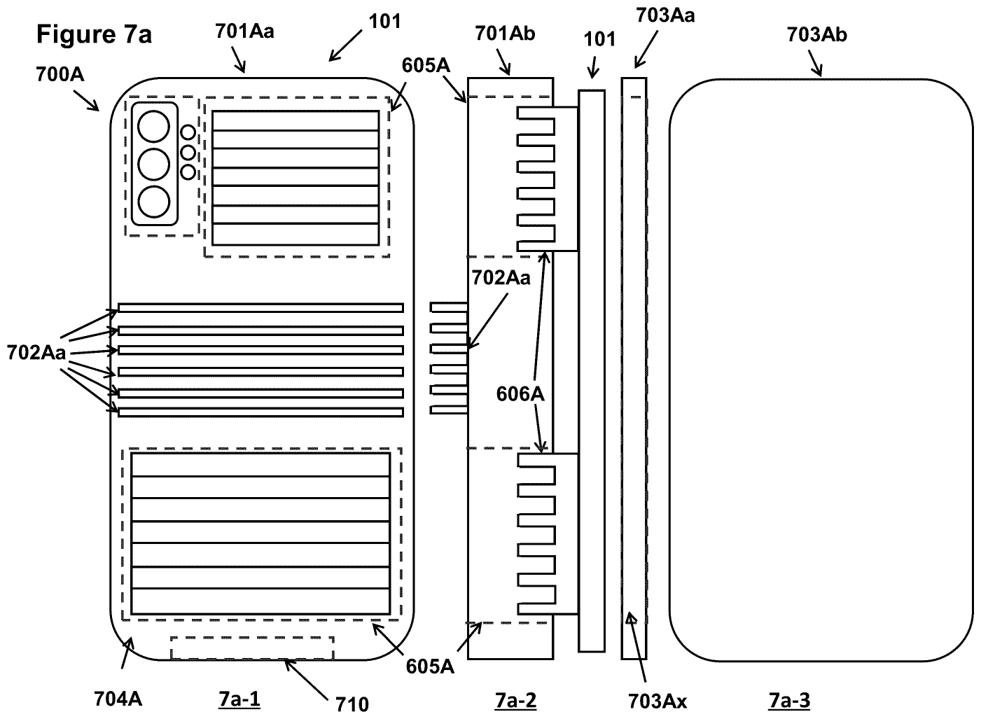

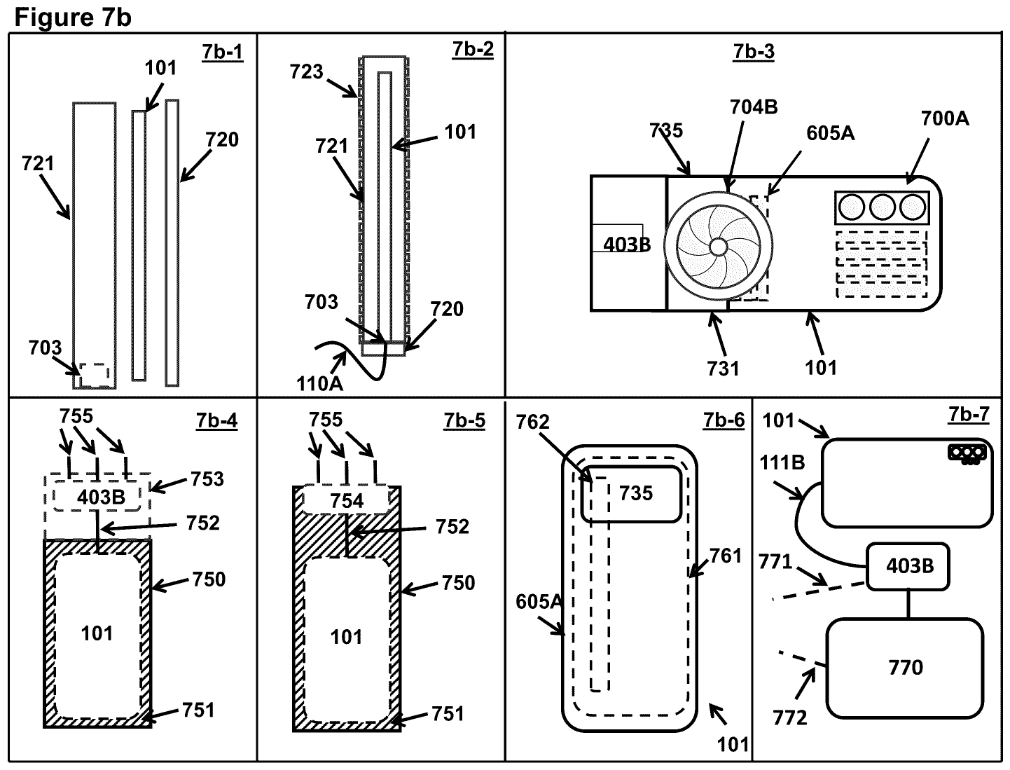

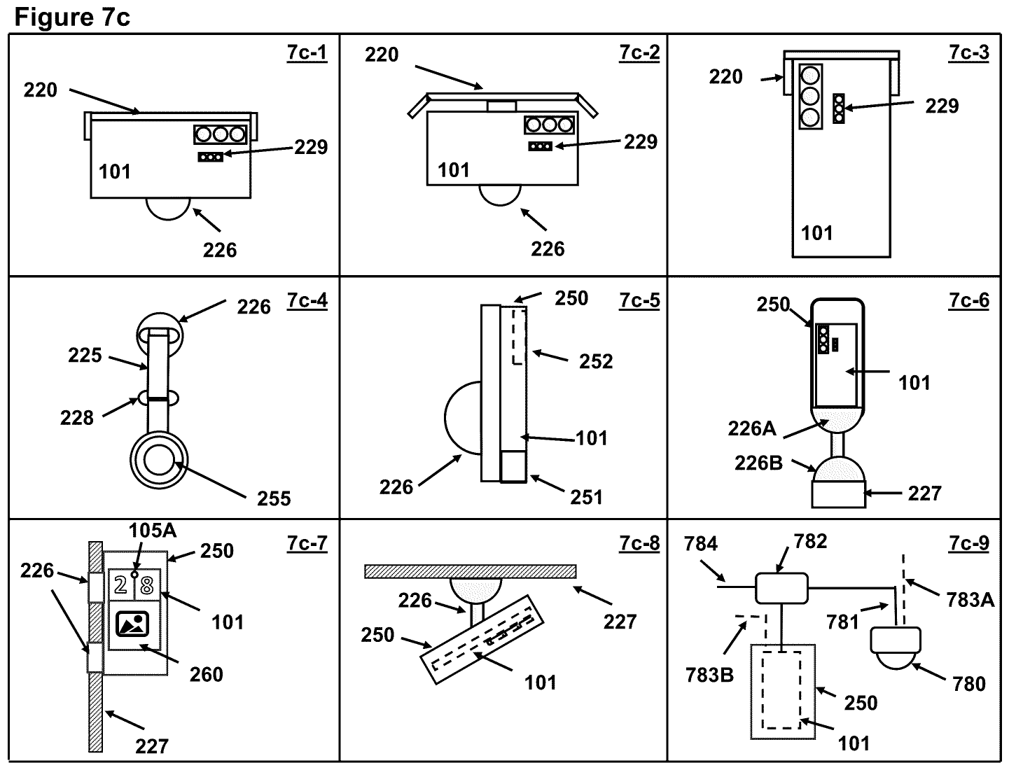

With reference to FIGS. 6 and 7a, it can be, in some embodiments, that the original device's 101A backplate 605A can be switched all together with a custom backplate 605A which has superior thermal conductivity properties, such as integrated fins for passive cooling and/or a fan. If using a custom backplate 605A, the design can be different such that the modified device 101 will no longer resemble the look of the original device 101A. In such a case, it can be that it may not be needed to utilize an external enclosure 700A to encompass the device 101.

Since the battery 215A can take up a large portion of the interior of the modified device 101, once it is removed 302A or excluded by design 302A (see FIG. 3) as part of the electrical modification 400A to the smart device 101A, there is a portion of the interior 610A of the modified device 101 that is left vacant-see FIG. 6. Since air is a poor thermal conductor, it can be referred to as a thermal insulator, especially when trapped in a constrained space, such as the interior of a smart device. As such, it is not favourable, from a heat management perspective, to keep a large portion of the interior 610A of the modified device 101 filled with air. Therefore, an embodiment of the invention replaces the battery 215A in the interior 610A with a thermally conductive material 602A (an additional component to that of the retained set of smart device components) such as a metal or metal alloy (for example, copper plate or aluminum alloy) or a thermally conductive material such as a conductive pad, layer, film, tape, adhesive, rubber, or composite material.

The filling material 602A can be tooled, cut and/or manufactured to have dimensions similar to the device's 101A battery 215A and can be attached to the interior 610A using compression, screws, bolts, latches, tabs, adhesives, and/or other means. It can also include a thermally conductive fluid or paste that is applied to the interior 602A of the device. It can also use thermally conductive paste 604A and/or adhesive material 604A to fill air gaps between the interior 610A surface and the material 602A to increase heat transfer rate between the heat generating components of the modified device 101 and the conductive material 602A. On top of the filling material 602A, there can be additional one or more layer(s) of thermally conductive material such as thermally conductive pad, tape or a thermally conductive metal or alloy 604A (while generally assuming it would not short electrical components, otherwise, it would have to be not an electrically conductive) in order to maximize the thermally conductive surface area which is touching the smart device's backplate 605A.

The modified device's 101 backplate 605A can be the default plate with which the smart device 101A is originally provided. For simplicity, in this figure, the backplate 605A is a comprehensive term which can include other assembly components (e.g., backplate 605A and midframe components) used for the modified device 101 to function.

The backplate 605A can be smooth. A common principal in heat dissipation from an object temperature to ambient temperature, is increasing the contact surface area of the object to be cooled down with air using a highly thermally conductive material (such as aluminum alloy). As such, a thin two sided thermal tape 604A or thermal glue 604A can be used to attach a heat sink 606A to the backplate 605A of the modified device 101. The heatsink 606A can be made of a corrosion resistant material such as an aluminum alloy. The heatsink 606A can also be anodized. The backplate 605A and front part 601A can then be re-attached using an adhesive (which can be thermally conductive), which can help to maintain the modified device's 101 resistance to water and dust ingress. The heat sink 606A can be attached to the exterior of the backplate 605A, however, it can also be mounted directly inside the interior 610A and slot through a prefabricated or cut-out opening in the backplate 605A, as desired.

In some embodiments, it can be preferable to keep the dimensions of the modified device 101 smaller, and as such, it can be that no components are attached to the modified device 101 exterior plates 601A, 605A.

Referring to FIGS. 7a, 7b and 7c, there are depicted various cases, enclosures and/or attachments which can be applied to the modified device 101, wherein the modified device 101 can be further packaged in a custom enclosure 700A or rugged off the shelf enclosure 700A in order to help and support its use in home, personal, office, industrial, indoor, outdoor, vehicle, aerial, vessel, platform, robot, drone, defence and/or other applicable settings. A rugged enclosure 700A therefore can help to mitigate physical damage (for example tampering, collisions, accidental drops, etc.), environment damage (for example, exposure to dust, water, direct sunlight, and/or extended hot and/or cold operating temperatures). FIGS. 7a,7b, and 7c depict one or more enclosures, for example, 700a, 7b-1, 7b-3, 7b-2, b7-3, 7b-4, 7c-1, 7c-2, 7c-3, 7c-4, 7c-5, 7c-6, 7c-7, 7c-8, and 7c-9. It is recognized that in some instances, the modified smart device 101 can be packaged in multiple enclosures. For example, the modified smart device 101, enclosed in a modified smart device enclosure 700a, and then further enclosed in a modified smart device enclosure 7b-3. It is also recognized that in some embodiments the first enclosure (for example, 700a, 7b-1, etc.) and second enclosure (for example, 7c-1 to 7c-9) can be combined to form one enclosure.

Referring to FIG. 7a and FIG. 1, the modified device 101 can be enclosed between a front plate 703Aa and a back plate 701Aa. It is recognized that the modified device 101 can have for example a display screen 107a. In some embodiments, the front plate 703Aa can provide an access to the screen 107a through cut out space 703Ax. In some embodiments, the front plate 703Aa can also have further options to cover the cut out space 703Ax can be further covered by a front cover 703Ab, for example, to prevent unauthorized persons from accessing the device modified 101 display screen, or for example, to make the modified device 101 look less like a modified smart device 101 to reduce the risk of a theft. A user can, for example, orient and/or configure the device cameras 106A, and/or interact with the modified device 101 prior to completely covering the screen to prevent further access to the modified device 101.

The modified device 101 can be placed inside the enclosure 700A. The enclosure 700A or packaging can have one or more cut-outs 605A to allow a modified device 101 heat sink 606A to transfer the internal heat to ambient temperature through contact with air in order to maintain heat dissipation. In other embodiments, the back side of the case 701Aa, 701Ab can also one or more heatsink(s) 702Aa, such as ridge(s), edge(s), fin(s), or heat dissipating modules formed as part of the back plate 701Aa, 701Ab. FIGS. 7a, 7b, and 7c show further examples where heat sinks (whether as formed, or modified versions thereof) can be adhered to the enclosure back plate or directly contacting the device components. The cut outs 605A can allow heat sinks 606A to extend through the case back plate 701Aa, 701Ab. It is recognized that the modified device 101 can have none, one, or more than one heat sinks 606A. It is recognized that the modified device 101 can have none, one, or more than one heat sinks 702Aa. It is recognized that the combined modified device 101 and enclosure (including any one, some, or all components thereof) 701Aa, 701Ab, 703Aa, 703Ab can have none, one or more heat sinks 606A, 702Aa. It is recognized that the modified device 101 enclosure 700A can include one or more port access cut outs 710, to allow for access 710 to power ports, connectors, speakers, microphones, buttons, or other smart device components (not shown) which require external access in order for the modified smart device 101 to function.

Referring to FIGS. 7a and 7b, the modified device 101 can be simply packaged 7b-1 within a back plate and a front plate 720 which substantially encompass the modified device 101 (in this embodiment 7b-1, shown without heatsinks 606A), other than access port/cutout 703 for power and/or USB connector (not shown).

In another embodiment 7b-2, the modified smart device 101 can be encompassed in an enclosure 721 made from a thermally conductive material which can optionally be further augmented with a heatsink which is either available by design (for example, machined aluminum pattern 723 which grows the enclosure 721 surface area. Examples of the machined aluminum pattern 723 comprise grooves, slits, cuts, fins, diamonds, triangles, wavy, serrated, louvered, straight, perforated, offset or other heat dissipating patterns 723), or similar. It is recognized that the hybrid smart device 101 can be further enclosed through a plate 720 with a hole allowing a power and/or interface cable 111A (for example USB-C cable 111A) into the enclosure and connecting the modified device 101 externally through the cable 111A. It is recognized that the heat dissipating pattern 723, if employed, can be on any of the exterior sides of the enclosure(s) 721 and/or plate(s) 720.

In another embodiment 7b-3, the modified hybrid device 101 can be already packaged in a custom enclosure 700A with one or more optional fan 704B module(s) 735 which would typically blow air on a heat sink 605, and which can be used in some situations where active cooling is required. The fan 704B can be attachable module 735, or directly mounted to the enclosure 700A encompassing the smart device 101. The fan module(s) 735, 704b can be powered by an external circuit 403B which also powers the modified device 101 or through a separate power module (not shown). The fan may be, for example, a centrifugal fan 704B that delivers air and moves heat away from sensitive components. A ir flow can also be single pass, or multi-pass, using air or heat transfer liquid (not shown). Moreover, multiple fan(s) 704b and/or fan types covering one or more heat dissipating surfaces 700A, 605A can be used to ensure sufficient air flow to remove the heat generated from smart device 101. In some embodiments, it can be useful to utilize the one or more integrated fan(s) modules 735, placed on top of the heat sink 605A in order to move ambient air over the heat sink 606A to accelerate the rate of heat dissipation. When fan 704A is used, it can be powered through the power supply 401A using a second power cable (not shown), or can tap into the device's custom power 403A circuit in order to power the fan 704A up. The fan 704A can also be temperature activated/deactivated based on an embedded temperature sensor comprising part of the temperature control circuit 403A e on one of the power circuit(s) 403A, 403B, and/or controlled by a microprocessor 403Af—see FIG. 4.

As per 7b-4, It can be that the modified smart device 101 is wholly placed in an enclosure 750, in which the enclosure 750 is filled with heat dissipating material 751. The heat dissipating material 751 can be a thermally conductive material, such as potting compound, gel, foam, fluid, or a compressible solid or semi-solid material. The encompassing material 751 can be a liquid that cures to a solid or flexible mass, or a semi-fluid material such as a gel, or a non-curing liquid. Examples of materials can include variants of epoxy, silicone, polyurethane, silicone gel, soft putty, dielectric fluids, fluorinated fluid, engineered fluid, hydrocarbon, soft pads, foam pads, or similar. It is recognized that many smart devices 101 are water resistant, and as such, even water can be used, whether or not inclusive of anti-corrosion additives. The enclosure 750 can include an allowance for a wire 752 (for example, a USB-C cable) to pass through. It is recognized that in some embodiments, the power/interface 752 can be split using an attachable module 753, which includes an external circuit 403B (e.g., power splitting circuit or USB hub), which can provide multiple interface cables 755 and/or power cables 755 and/or ports 744. For example, for peripherals, power and/or communication adapters (for example, wired Ethernet) may be provided. It is recognized that in some embodiments the modified device 101 can have a connected 752 interface module 754 and/or power module 754 contained within the same enclosure, and one or more power and/or interface ports, connectors, and/or cables.

It can also be, such as shown in 7b-6, that cooling of the internal components of the modified device 101 can also be carried out by use of cooling component(s) 762, such as a vapor chamber and/or heat pipes to move heat by an evaporation/condensation heat transfer cycle. The heat pipes or vapor chambers can contain for example water, ethanol, or other heat dissipating materials. The choice of the fluid would depend on the planned installation location of the device. For example, water can be used in areas that do not face freezing temperatures, while ethanol can be used in locations where temperatures are expected to drop below freezing. These cooling components and thermal interface can be positioned on top of the heat generation sources and can be a single large cooler 761 or a combination of many smaller coolers 761 which can be independent from each other.

Other methods can include attaching an internal heat sink (for example, copper plate, graphene plate, thermal pad, aluminum plate, graphite plane, diamond, metal, silver, carbon nanotubes, beryllium oxide, aluminum nitride, silicon carbide, metal composites, or other materials which can distribute heat within and across a smart device 101). To ensure that there is adequate contact an additional material can be added to the interface such as a thermal gel or liquid metal to bridge the gap between contacting surfaces (not shown).

Referring to FIG. 1 and FIG. 7b, it can be, that the original back plate 101A can be switched all together with a custom backplate 605A which has superior thermal conductivity properties, such made from thermally conductive materials as described herein or having a heat dissipating pattern 723 such as integrated fins for passive cooling and/or integrated fan 704B. If using a custom backplate 605A, the design can be different such that the modified device 101 will no longer resemble the look of the original smart device 101A. In such case, it may not be needed to utilize the enclosure 700A to resemble that of the original smart device 101A.

The modified device 101 enclosure can also accommodate a connection 111B, through a circuit 403B (e.g., an interface splitter) to an external battery 770 which can power the device 101. In different embodiments, the circuit 771 can charge the battery, or the battery 770 can be charged directly by an external 772 power source.

With reference to FIGS. 1, 4b, 7a, 7b, and 7c, the modified device 101, its enclosure 700a, or larger housing 490 can include a hood 220 attachment. The hood 220 can protect the modified smart device 101 from the environmental elements such as rain, snow and direct sunlight. The hood 220 can be attached to the enclosure 700A of the device 101, or to a larger housing 490 containing the modified device 101. The hood 220 can be formed as apart of housing 703A, part of the larger enclosure 490, or in separate pieces. The hood 220 can be comprised of one or more pieces that attach together and protrude over the various device components and attachments in such a manner that at least protects the modified device from direct contact with environmental elements. The hood 220 can be made of one or more durable materials suitable for withstanding weathering conditions such as aluminum, heavy duty plastic, steel, silicone and/or material composites. The hood 220 can be oriented to match the parallel plane to the field of view of the camera. The hood 220 protrusion can be flat 7c-1, angled 7c-2 to one or more directions or curved (not shown). It is recognized that the modified device 101 in different embodiments can be oriented in landscape 7c-1 or portrait 7c-3 mode. It is recognized that in different orientations (7c-2, 7c-3), the modified device 101 image sensor can also capture images in landscape or portrait mode. The modified device 101 can also include one or more lighting capabilities (for example, integrated flashlight) or one or more other light based sensors (for example, time of flight sensor).

The device enclosure 700A or larger housing 409 can be painted, anodized, or manufactured from materials which use colors which effectively reflect direct sunlight, helping to passively cool the device 101 in hot environments or under direct sunlight.

The mounting component of the device 101 can come in one or more parts which include a mounting bracket 226 which will be attached to the supporting structure 227 (e.g., a window or fixture) and a second attachment bracket 226 which will be attached to the modified device 101. The supporting structure 227 can be a pole, wall, metal bars, ceilings, overpasses, bridges, light pole, signage/signage support, traffic lights, windows, windshield, frames or other surfaces which support the use of a mount 226. Each of these brackets 226 can be fixed or have at least one degree of freedom to shift the plane of the mounting bracket 226. Additionally, the connection to the mounting brackets 226 can be attached by an arm 225 with no articulation joints 228 or one or more articulation joints 228. These joints 228 can be independently locked or unlocked in place by knobs, bolts, screws, keys, clips, epoxies, cements, welded in place and/or using specialty cut inserts.

In some embodiments, the supporting structure 227 can have hole(s) 255, conduit(s), space(s), gap(s), or accommodation(s) to run power directly through the mounting assembly. See 7c-4 227 for example. It can also be that the modified device 101 is stored inside another enclosure 250 which mounted to a wall. The modified device 101 can be attached to the enclosure 250 using adapters 251, sockets 251, connectors 251, assemblies 251, modules 251, hardware 251, arms 251, bolts 251, panels 251, and/or other mechanisms 251. It is also recognized that the enclosure can have gaps 252, slits 252, holes 252, windows 252, panels 252, lens 252, or other viewports 252 which can allow a modified device 101 to view the exterior of the enclosure 250. The modified device 101 can also be attached, directly or through an enclosure 250, to a pan tilt 226A mechanism which can be further attached 226B to a surface. It is recognized that the modified device 101 can be mounted onto different supporting structure(s) 227 at different orientations, for example upside down (for example, as shown in 7c-8) or in any other orientation, direction, tilt, pan, or angle which is supported by the surface, enclosure 250 and/or mounting mechanism (e.g., bracket 226), and/or combination thereof. Some example applications of embodiments 7c-1,7c-2,7c-3,7c-5,7c-6,7c-8 can be those of a smart camera device 101 used for monitoring applications, which can also leverage computer vision (whether single modal, or multi-modal) artificial intelligence.

It is recognized that the modified hybrid smart device 101 is not limited for use as a smart camera 101, but can also be used as a smart display 101. For example, the modified smart device 101, can be used as a smart display 7c-7 (which can also include smart camera 101 functions as an option). For example, the modified smart device 101 can be partially or fully enclosed in an enclosure while its display 107A is visible. In some embodiments, the display 107A can directly face the exterior of the enclosure 250. In other embodiments, the display 107A can be further protected by a protective transparent material 260 (e.g., film, glass, tempered glass, epoxy wall, and/or similar transparent material). It is recognized that in some embodiments the display 107A can be a touch screen which allows a user to interact with the display 107A. For example, the hybrid smart display device can function as a kiosk 7c-7, smart transit stop 7c-7, smart sign 7c-7, smart display 7c-7, smart terminal 7c-7, commercial kiosk 7c-7, industrial computer 7c-7, traffic control device 7c-7 and/or other use cases which can leverage the built in functions of a smart device 101A for use as a hybrid smart display 101. It can be the hybrid smart device 101A can utilize its one or more cameras 105A, 106A in conjunction with smart display functions. For example, the smart camera 101 functions can turn the display 107A on or off when people or cars are in proximity, or not in proximity, of the smart display 101. For example, the smart camera 101 functions can perform additional monitoring functions 101 (for example, counting people, cars, detecting objects of interest, conditions, etc.) while the smart display 101 is displaying information. For example, the smart camera 105A can extract demographic information (for example, age, gender, ethnicity, or otherwise) which would tailor the content that is displayed on the screen 107A.

The modified smart device 101 can also perform purely as an edge computing device 101 capable of leveraging the inherent computing functions of the smart device 101A (for example, machine vision, audio analysis, text analysis, computer functions, display functions, text analysis, audio notifications, etc.). For example, as per 7c-9, the modified edge device 101 can be placed in an enclosure in proximity to a video surveillance camera 780, IP camera 780, CCTV camera 780, IoT camera 780, web camera 780, and/or other camera 780 device. The external camera 780 can stream video or image data through a wired 781 or wireless (not shown) connection to the modified edge device 101. The modified edge device 101 can share the same power and/or communication as the CCTV device 780 through a power/communication box 782 or terminal. It can also be in other embodiments that the modified smart computer 783B and camera 780 are powered separately 783A, 783B.

It is recognized that the various thermal, mechanical, and electrical embodiments described in this disclosure can be combined in part or in full. For example, the modified device 101 of FIG. 4a can be filled with thermally conductive material(s) such as the material(s) 602A, 604A disclosed in FIG. 6, and included in an enclosure which has a thermal conductive pattern 723 and filled with a thermally conductive material 751 and connected to an external device, such as an IP camera of FIG. 7c. There are a significant number of permutations which can take place; however, the teachings of the present disclosure can be applied to modify a smart phone device 101A or a tablet device 101A, to a modified hybrid device 101 capable of performing a variety of different functions for different purposes, which would not be possible without the modifications.

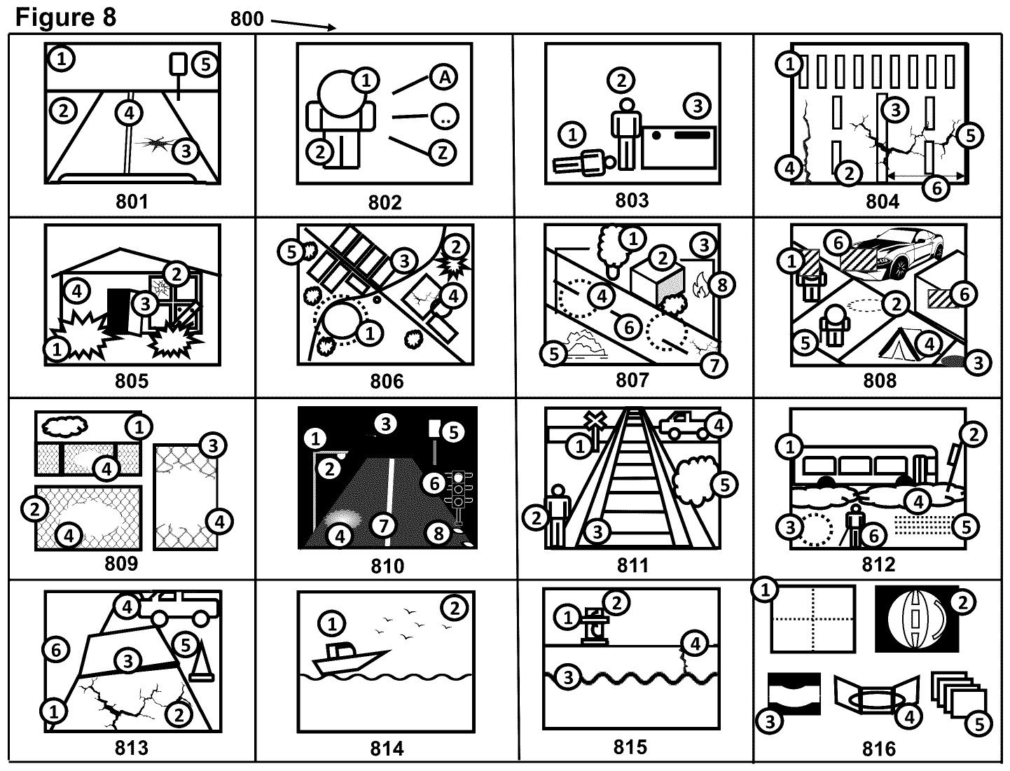

Referring to FIG. 8, there are depicted different examples 801, 802, 803, 804, 805, 806, 807, 808, 809, 810, 811, 812, 813, 814, 815, 816 of image(s) 800 and/or video(s) frames 800 which can be processed by the modified hybrid computing system 101 (for greater clarity, video streams/files being processed can also be covered under this embodiment, but for the sake of expediency, this example will refer primarily to images). It is recognized that the data can be provided as a series of frames suitable for digital processing by image processing functions on the modified hybrid device 101.

The modified device 101 can be deployed on a variety of locations (e.g., vehicle, drone, platform, carried, fixed, etc.). In many instances, the modified smart device 101 can have its one or more internal camera(s) 105A, 106A or external camera(s) 780 capture image and/or video data in various formats, from various perspectives, under various environmental conditions, under various lighting conditions, and containing various objects such as but not limited to specified incidents, issues, conditions, assets, inventories, and/or information of interest, and/or a combination thereof. Those image(s) can be processed for recognition in various ways, for various purposes, and with various results.

Sample image 801 depicts an image captured from a vehicle using a dash cam utilizing a modified hybrid device 101. The image 801 can be processed using image processing instructions in various ways, for example: to log the weather conditions (day/night, clear/partial cloud/cloudy, raining, snowing, etc.) 801-1 in the image 801; to search for objects of interest in the surroundings 801-2; to identify deficiencies (for example, pavement deficiencies 801-3 such as potholes, cracks, deformations, etc.); to identify asset(s) (for example, lane markers 801-4 and/or signs 801-5) for inventorying, and/or assessing asset 801-4, 801-5 conditions; for determining visibility of an asset (for example, a sightline to a traffic sign 801-5); and/or for other purposes;

Sample image 902 depicts an image of a person (for example, a person operating a kiosk at a mall), or a pre-processed image 802 for example, a person's face) captured by a kiosk powered by a modified smart device 101. The modified device can be used in various ways, for example: to determine in the image any identified objects such as but not limited to object category and/or subcategory (for example, person 802-1, gender, age, demographic 802-A . . . . Z), whether by name or by code; to identify any related objects 802-2 (for example, clothes 802-2, safety gear 802-2, weapons 802-3), to assess the object 802-1 and/or related objects 802-2 and report conditions (for example, a person is carrying gun); and/or for other purposes;

Sample image 803 depicts a transit stop captured by a modified hybrid smart display 101. The image 803 could be analyzed in various ways using image processing instructions, for example: to identify objects such as but not limited to asset(s) (for example, a bus stop waste bin 803-3); to identify issues at the transit stop (for example, a fallen person 803-1); to determine occupancy and/or facility use at the stops (for example, determining the number of people 803-2 at a stop, determining if they are using stop amenities, etc.); and/or for other purposes.

Sample image 804 depicts a high resolution orthogonal image of road infrastructure captured by a UAV, a plane, or a drone employing a hybrid smart device 101. The image 803 can be processed in various ways using image processing instructions and/or artificial intelligence, for example: to assess the infrastructure for instances of failures (for example, linear cracks 804-4, alligator cracks 804-5 and/or other failures); to determine the position and/or condition of related objects (for example, linear lane markers such as dashed white 804-2, solid yellow 804-3 and/or transversal lane marker(s) such as crosswalks 804-1); to measure the linear, area or volume dimensions of objects in images (for example, to determine the width 804-6 of the road); to derive new data, such as a pavement rating score (not shown) and/or lane marker deficiencies (not shown); and/or for other purposes.

Sample image 805 depicts a street level imagery of a residential property acquired by a vehicle (or a drone/robot) with a hybrid smart camera 101. The modified smart device 101 AI can be applied determine the condition of the property (for example, assessing the quality and/or value of the exterior finish 805-4 of the property); to recognize deficiencies in the property (such as, for example, broken door 805-3, broken window 805-2, or other deficiencies); to recognize bylaw infractions, such as lack of lawn maintenance 805-1; to retrieve newly generate data, such as a property quality rating (not shown) which could be used, for example, to refine the estimated value of the property; and/or for other purposes.

Sample image 806 depicts an orthogonal image captured by a UAV employing a modified smart camera 101. The artificial intelligence may be utilized in various ways, for example: to identify variations in images 806; to identify issues such as flooding 806-1; to provide alerts about noxious, sick, and/or invasive vegetation species 806-2; to measure urbanization and building within a city and/or an area (for example, by measuring the surface area of all buildings 806-3); to pinpoint/determine the GIS coordinates of assets (for example, trees 806-5); to measure canopies of trees for determining green space 806-5 within an area 5; to identify building and/or infrastructure failures (for example, cracking 806-2 and/or water ponding 806-4); and/or for other purposes.

Sample image 807 depicts CCTV camera footage captured in an urban area and analyzed by a modified edge device 101. The imagery may be processed in various ways, for example: to identify and/or classify the types of asset(s) present in the image and their location (for example, trees 807-1, buildings 807-2, lighting poles 807-3, lane markers 807-6); to assess performance, compliance and/or coverage of certain requirements (for example, to identify and/or assess the lighting coverage 807-4 in a particular area); to identify incidents, hazards or bylaw compliance issues (for example, to identify illegal garbage dumping 807-7, or a smoke or fire 807-8); to identify infrastructure issues (for example, to identify cracking on infrastructure 807-7); and/or for other purposes.

Sample image 808 depicts an image extracted from video footage of a public space which is being processed by the modified smart device 101. The onboard artificial intelligence could be employed to analyze the image 808 in various ways, for example: to determine whether the area is occupied or not occupied (for example, by identifying if any people 808-1, 808-2 are in the image or none); to redact personal information, such as faces 808-1, license plates 808-2, home address 808-7, and other private information); to recognize people's faces 808-1, license plates 808-2, or home address 808-7, and match them against a white list, black list or a database); to determine the level of occupancy in an image (for example, by counting the number of persons 808-1, 808-2 in an area); to determine the demographics of persons 808-2 in an area (for example, age range, gender, ethnicity); to identify hazards in an area (for example, the formation of ice 808-8, open manholes 808-8), to identify application of maintenance services, for example provision of salt 808-2 or removal of an object 808-4; to identify bylaw infractions, social issues, or requirement for intervention (for example, detecting encampment(s) 808-4 in an area, illegal parking 808-6, encroachment, 808-6); and/or for other purposes.

Sample image 809 depicts a captured image acquired by a police body cam powered by a modified camera 101, via a robot inspection system utilizing hybrid camera 101, or captured on a side view from a hybrid train camera 101. The image 809 could be of a wide angle view 809-1, regular view 809-2, or a zoomed-in view 809-3. The image can be in portrait mode 809-3 or in landscape mode 809-2. The image 810 can include for example, an instance of a deficiency in an asset (for example, a fence), whereas the deficiency is a cut hole 809-4 in the fence 809-4; and/or for other purposes.

Sample image 810 depicts an image captured from a connected and/or autonomous vehicle equipped with a hybrid modified device 101. The images can be analyzed using AI or image processing instructions (single modal or multi-modal) to determine the location of asset(s) at night, such as lighting poles 810-1; to determine whether assets are powered (for example, whether street lighting 810-2 or traffic signals 810-6 are functioning at a specific time or functioning at all, and whether the street lighting 810-3 or traffic signal lighting 810-6 is not functioning at a particular time or functioning at all; to determine luminance level of bulbs 810-2, 810-6; to determine retro reflectivity of lane markers 810-7 or signs 810-5; to determine position of light reflectors 810-8 and intensity of reflections; to view which areas are lit 810-4; to generate night visibility scores (not shown); and/or for other purposes.

Sample image 811 depicts an image extracted from an onboard train CCTV system and processed by a modified edge compute unit 101. The extracted image(s) and corresponding location(s), may be used to identify, inventory and/or assess assets along the train tracks (for example, signage 810-1 or signaling equipment); to generate alerts and records about near misses with pedestrians 810-2 or vehicles 810-4 or debris (not shown) along the tracks; to determine which locations require trimming of vegetation overgrowth 810-5; to inspect the condition of the train tracks 810-3; and/or for other purposes.

Sample image 812 depicts a modified smart device 101 packaged as a smart camera monitoring a transit stop. The modified AI capable device 101 can determine at which location a bus 812-1 stops at a bus stop; to determine if there are any potential issues, such as a leaning sign 812-2; to determine whether there is ice 812-3, snow 812-4, and/or water pooling at the stops; to determine whether the stop was maintained, for example, by salting 812-5 it during winter and/or clearing snow 812-4; to identify whether there are any persons 812-6 (including persons with mobility problems), and whether they experienced any issues; to measure how one or more person(s) 812-6 are waiting at the stop; and/or for other purposes.

Sample image 813 depicts an image obtained from a robotic sidewalk inspection platform, or from an e-bike, equipped with a modified device 101 packaged as an inspection system, whereas image(s) and/or footage along with corresponding location data is uploaded to the server(s) for processing. The information contained in the video or images can be further processed on the modified device 101 or a server in different ways, for example: to rate the condition of the sidewalk 813-1 and identify distresses along the way (for example, cracks 813-2, deformations 813-3, and other distresses); to provide warnings about hazards (for example, trip edges 813-3); to provide alerts about bylaw infractions (for example, encroachment of a vehicle 813-4 onto sidewalk 813-3); to determine whether a hazard is flagged (for example, through warning cone 813-5, hazard tape, or spray paint); and/or for other purposes.

Sample image 814 depicts video recording captured on a coastal monitoring technology platform (such as an unmanned ground vehicle, unmanned vessel, monitoring tower, or a boat) and further processed by a modified hybrid edge device 101. The modified device could process the video recording (and/or images thereof) using single modal AI (i.e. computer vision AI) or multi-modal AI (for example, text and image captioning) to: identify the incident reported (for example, the presence of a boat 814-1); to recognize the object present in the image (for example, the ID or name of a boat 814-1); to detect, localize, quantify, recognize and/or classify species of wild life 815-2 or vegetation (not shown) and/or for other purposes.

Sample image 815 depicts an image obtained from a water based platform, such as a boat or a remotely operated vehicle (ROV); the boat or ROV onboard edge computing 101 can process the image data from the boat/ROV imager sensors, for example, to identify asset(s) (for example, mooring 815-1); to assess the condition of assets (for example, identifying signs of rust 815-2); to identify and log infrastructure issues (for example, cracks 815-4); to determine the water level 815-3; and/or for other purposes.

Sample images 816 depict other format(s) of images which can be processed by the modified smart device 101, for example: multiple images which are stitched together 816-1; fish eye image(s) 816-2 and/or images 816-3; panoramic image(s) 816-3; monoscopic, stereoscopic, or multiscopic 816-4 image(s) whether captured in a synchronized manner or not; multiple image(s) depicting the same scene from multiple perspectives 816-5; multiple image(s) which are processed together using the image processing instructions 820 (whether in sequence or concurrently), whether synchronized or not, whether for the same purpose or not, whether de-warped or not, and whether padded or not; and/or for other purposes. The examples noted in 801-816 are simply meant to demonstrate few of many possible embodiments of image(s) and or video(s) that the modified device(s) 101 can process, and are not meant to be exhaustive.

Referring to FIG. 9, there are depicted sample embodiments of possible physical and logical components of a modified smart device 101 (from which the battery was already removed), and one or more remote server(s) 111. The server(s) 111 can communicate (send or receive data D) to/from one or more modified device(s) 101. A modified device 101 will typically collect data D locally on a non-volatile local storage 99 (such as disk, hard drive, solid state memory, or other types of non-volatile memory) until such time that the modified smart device 101 is programmed to transmit data D to a server 111.

The modified device 101 consists of a plurality of hardware and software components that are configured to automatically collect at least visual (but also sometimes location and/or sensor) data 107 while affixed to a building, vehicle, platform, structure, or other mountable scenario (for example, building, pole, ceiling, window, vehicle, robot, drone, vessel, aircraft, human, or any other place it can be mounted and powered). Components that make up the modified device 101 are embedded in the computing system/infrastructure 900. FIG. 9 is for illustration only and it is recognized that a modified device 101 is composed of many components which vary between smart device to smart device. For example, there can be variance in components between manufacturer to manufacturer, such a variance between an Apple™ smart device and Samsung™ smart device. For example, there can be variance in components between different smart devices; for example, a Samsung™ smart phone and a Samsung™ tablet. For example, there can be variance between similar smart devices but different product lines, such as a variance between Samsung Galaxy™ S series to A series. For example, there can be variance between a generations of the same product line, such as a variance between Samsung Galaxy™ S20 to S22 to S24 to another S series device). It is recognized that this innovation is not particular to the components of the smart device, but rather the ability to transform any smart device (for example, smart device 101A of FIG. 1) to a modified hybrid device 101, which allows it to function and/or interact in different ways. Below are described some computing/processing components which, from a functional perspective, can be utilized in the hybrid smart camera 101/hybrid smart display 101/hybrid edge compute unit 101 embodied as the modified device 101.

The modified device 101 can be inclusive of one or more central processing unit(s) (each a CPU) 120, one or more graphics processing unit(s) (each a GPU) 121, and/or one or more additional processing unit(s) 131. The processing unit(s) 120,121,131 can be separate or come as an integrated chipset. The modified device 101 can also include memory, such as non-volatile memory 122 and/or volatile memory 99 (e.g. a high speed volatile memory such as RAM), which facilitates the modified device 101 to execute its software 708a (e.g. operating system, artificial intelligence software 905a such as image processing instructions, etc.).

The modified device 101 can also have non-volatile memory 122 that can be associated with storing files 706 associated with operating system(s), component driver(s), application(s), and media, alongside other software applications resident in memory 99 of the modified device 101. The device 101 operating system (e.g. part of the software 708a) can be such as a windows operating system, android operating system, Linux operating system, or other operating system, whether embedded or not.

The modified device 101 (also referred to as a hybrid smart device 101) can also have a read only memory (not shown) for storing instructions necessary for operation of the modified device 101. The modified device 101 can also have one or more data transmitting and receiving components (communication components operating a network interface 113 to the network 110) which can be wireless. Further, the modified device 101 can interface with external wireless communication components 117 via wired connector 115, such as a USB connection, in order to transmit the data D over the network 110 to the server 111, as an example. It is further recognized that the hybrid device 101 can also communicate with one or more other device(s)/system(s)/sensor(s)/module(s) 950 which can be connected over a network 110. For example, the device(s)/system(s)/sensor(s)/module(s) 950 may comprise any one or more of CCTV camera(s), video surveillance camera(s), video recorder(s), license plate reader(s), microphone(s), speaker(s), display(s), kiosk(s), computer(s), unmodified smart device(s), smart phone(s), tablet(s), IoT unit(s), network unit(s) (such as routers, modems, switches, repeaters, etc.), robot(s), smart vehicle(s), technology platform(s), integrated system(s), or any other system 950 that can send or receive data to or from the modified smart device 101.

Further, the modified device 101 can have a display, built-in 960 or external, in order to display information from the modified device 101 (for example, when functioning as a modified smart kiosk, or modified smart bus stop, or modified smart display, or modified smart camera, or modified hybrid unit). When operated remotely the device transmits its data D through the internet using a network connection 109. The display 960 information provided by the modified device 101 can include but not limited to the camera 500 field of view (viewfinder), the orientation of the modified device 101, status indicators, settings, parameters, and other information related the installation, configuration operation, and maintenance of the modified device 101. It can also include menus, advertising, schedules, maps, controls, announcements, and/or any other displayable information.

The modified device 101 can collect a variety of sensor data 107. In addition to camera(s) 500, the device 101 is equipped with a geo-positioning 701 sensor. The modified device 101 can also include an accelerometer 702 sensor, gyroscope 703 sensor, rotational vector 704 sensor, and other sensors 705 that can provide information 17 regarding the movement, position and/or orientation of the modified device 101 and/or the structure/platform on which it is equipped. The sensor(s) 107 and camera(s) 500 data D can be processed by the software 708a (including the artificial intelligence software 905a, which may comprise artificial intelligence model(s)) before being sent to the server 111, as discussed herein. The sensor data 17 and image data 107 can be stored on the modified device 101 non-volatile memory 104 in the form of file(s) 706 or database 707 entries prior to being transmitted to the server 111.

The modified device 101 can include a geo-positioning sensor 701 and, with image processing capabilities, objects in the image can have their geo-position determined using AI against the object in the image 800. The device 101 can also have various sensors 107 that can detect weather such as rain, snow (determining reflectivity on the pavement or in flakes in the air), pollution, and lighting such as evening or day. The device can also contain infrared sensors 107 that can detect objects in the image 800 such as people or vehicles. The various sensors in the hybrid device 101 can detect heat from cars or people and determine the presence of either or both in an image 800. Different sensors can detect smog, pollution and precipitation because the device 101 can be outdoors to detect these levels, using image detection, coupled with artificial intelligence and neural networks. Using AI models and training the models, the amount of smog in the area can be determined. Also, rain or snow, including other precipitation, can be determined in the air and on the ground, based on the images 800 and/or data from external sensor 960. Vehicle accidents, speeding, distracted driving, pedestrians, and distracted pedestrians can also be detected by the modified device 101, including when implemented with artificial intelligence and neural networks. Using the device's geo-spatial sensors 107, the geo-position of the accident, speeding/distracted vehicle and pedestrians can be determined, using the sensors and also AI when processing the images. These are just examples and are not meant to exhaustively set out the types of objects that may be detected, classified, recognized, processed, derived, and/or reported by the modified device 101.

The modified device 101 can include a geo-positioning sensor 701 to determine its geo-spatial coordinates 17. Geo-location, or a geo-positioning sensor 701, provide location based information 17 using satellite (such as GPS, GNSS, GLONASS, Galileo) or cellular tower locations to determine device positioning information, which is associated with the images 800. In addition, the modified device 101 in many instances can have additional sensors 17. For example, modern smart devices 101A on the market today have a variety of sensors 107 embedded right onto them, which provide information 17 that can be used to determine the modified device 101 orientation, pitch, magnetic pole direction, geo-spatial position, relative velocity of objects being detected, acceleration, shock, vibration, weather, temperature and other data 17 related to position and movement. The modified device 101 can include an accelerometer sensor 702 used to measure the acceleration force 17 applied to the modified device 101 across its x axis, y axis and z axis. The force may or may not include the force of gravity. The acceleration data 17 will typically be available as meters per second squared (m/s²) though it can be in other units (for example voltage) that can be converted to such units. The modified device 101 can include a gyroscope sensor 703 used to measure the rate of rotation across the modified device's 101 x axis, y axis and z axis. The gyroscope data 17 will typically be available as radians per second (rad/s) though it can be in other units (for example voltage or frequency) that can be converted to such units. The modified device 101 can include a rotational vector 704 sensor used to measure the degree of rotation across the modified device's 101 x axis, y axis, z axis and an optional scalar product or quaternion. The rotational vector data 17 will typically be degrees, though it can be in other units (for example voltage) that can be converted to such units. The modified device 101 can include other sensor(s) 705 to measure a variety of other conditions 17 related to the movement, acceleration, forces applied and position of the modified device 101. For example, the modified device 101 can include a gravity sensor 700, which would measure the force of gravity 17 in relation to the modified device 101. Other sensor(s) 700 can also be a magnetometer which can determine the modified device's 101 position 17 in relation to the magnetic north or true north. Other sensor(s) 705 can also include hardware and/or software monitoring of the modified device 101 components. Examples of sensors 107 can include battery level sensor, battery temperature sensor, CPU temperature sensor, GPU temperature sensor, ambient temperature sensor, CPU core utilization, CPU overall utilization, luminance sensor, proximity sensor, air pressure sensor, humidity sensor, and other built in sensors available for the modified device 101. The modified device 101 can also be connected to other sensors 950 through wired or wireless interfaces.

The modified device 101 can contain specialized AI processors 131 which specifically support the execution of AI models in AI applications. These processors 131 can be digital signal processors (each a DSP) 131, neural processing units (each a NPU) 131, tensor processing units (each a TPU) 131, or any other name used to describe a specialised piece of hardware used for the purpose of loading, inferring, and/or processing AI models or data related to AI models. For example, the Qualcomm Snapdragon Hexagon™ is a specialized DSP/NPU architecture. The Snapdragon Hexagon™ DSP/NPU is a powerful component in mobile AI applications, designed to deliver high performance with power efficiency. The AI chip 131 architecture and operations enable it to handle complex AI computations and real-time data processing with speed and accuracy. This makes it ideal for tasks such as image and speech analysis, recognition and production, natural language processing, augmented reality, and single modal or multi modal applications (where a modality is a form of data such as visual, auditory, sound, verbal, text, numbers, etc.). Integrating the AI processor 131 into mobile devices enhances the capabilities of AI-driven features, and further expands the use cases in which the modified computing device 10 can be used.

With reference to image based operations, with artificial intelligence, all of the above discussed sensor type data (i.e. sensor data 17) can then be associated with camera(s) 500 images to determine additional insights. For example, artificial intelligence and the sensor data 17 can be used to derive the speed in which a vehicle is travelling, humidity, rain, snow, sleet, hail, winds, smog, pollution, position of people proximate to the camera and whether the modified device 101 is within a geo-zone, or the estimated geo-positioning of an object detected in an image 800 in relation to the modified device 101. The sensor data 17 can also be used to optimize the performance of the modified device 101 in relation to the current heat, power and processing situation.

The sensor(s) 107 and camera(s) 500 provide for data 108 to be acquired and processed by the software 708a. The resultant processed data D is then either transmitted to the server 111 or stored on the modified device's 101 non-volatile memory 122 until transmission can take place. The data D can be stored as file(s) 706 in one or more file formats, such as mp4, avi, jpg, png, bmp, xml, csv, txt, or in a proprietary format. The data D can also be stored in a database 707. The data D can be stored and transmitted in encrypted on non-encrypted format.

The data D can be further processed on a server 111 using the server's software 708b and image processing 905b or AI capabilities 905b. For example, the data D can be correlated assets, accidents, hazards, alerts, warnings, speeding, license plates, people, weather patterns, pollution and other information to derive additional insights. The images can be further analyzed for objects of interest or redacted using server-side AI processing 905b.

It is further recognized that the modified hybrid device 101 interior can also include custom power circuits 403A and/or thermally conductive material 602A which facilitates heat management. It is recognized that the more computationally intensive the hybrid smart device 101 is (for example, lots of images processing, video processing and/or AI inference), the hotter the modified device may get, and the more important thermal management will be using some of the previous methods discussed, whether intrinsic to the modified device 101, or extrinsic to it.

It is further recognized that the modified device 101 software 708a and/or specialized AI software 905a can support one or more AI models A, and/or different types of artificial intelligence models A, which can be processed by the CPU 120, GPU 121, and/or AI processing units 131. Examples of AI models can include technologies, architectures and/or providers such as GRT, BERT, Roberta, XLNET, T5, BART, ALBERT, ELECTRA, DistilBERT, ERNIE, LLAMA, Falcon, ORT, PaLM, Claude, Mistral, OpenAI, CNN, ResNet, EfficientNet, DenseNet, VGG, MobileNet, Inception, AlexNet, Vision Transformer (VIT), ConvNext, Swin Transformer, DeiT, BEIT, SAM, Mask R-CNN, Faster R-CNN, TYOLO, SSD, DETR, GPT, CenterNet, Whisper, Wav2Vec, HUBERT, DeepSpeech, Tactron, WaveNet, Fast Speech, RNN-T, VITS, EnCodec, CLIP, BLIP, LLava, Flamingo, Gato, Picaso, Kosmos, MiniGPT, DINO, Segment Anything, Owl VIT, Pali, ImageBind, Dall-E, Parti, Gemini, Prceiver, ChatGPT, Transfer Learning Model, Meta-Learning Model, Few-shot Model, zero-shot Model, One-shot Model, Mixture of Experts Model(s), GNN, GCN, GAT, GraphSAGE, PinSage, RGCN, Transformer GNN, GDL, HGT, Hypergraph Neural Network, Neural Network, FPN, Y amNet, WaveLM, Depth Anything, Midas, Quantized models, non-quantized models, NASNET, RegNet, ResNext, Shufflenet, SqueezeNet, AOT, LaMa, face recognition, license plate recognition, OCR, detection, classification, segmentation, keypoint, landmark, distance, modal, single modal, multimodal, pose, small, medium, large, semantic, instance, segmnetaiton, bgnet, bisenet, DDRnet, SLIM, Deeplab, FFNet, MediaPipe, MobileSam, PidNet, SINet, Unet, GAN, SESR, XLSR, Video MAE, diffusion, riffusion, Plamo, Phi, ControlNet, EasyOCR, or TrOCR. It is recognized that even within each model or architecture there can be variances, for example, in model revisions (v1, v2, v3 . . . vX), model size (for example, X megabytes file size or Y megabytes memory usage), number of layers (i.e. shallow network or deep network), number or type of model operations used in model design, connections between different layers or models, number of parameters used (i.e. small, medium, large, x million, y billion, etc.), dataset(s) used to train the model, number of neurons, number of iterations the model was trained on, batch size used in training, and/or other expected variances included within this disclosure.

It is recognized that these are only examples and additional models A are anticipated to be released in the future, which will be compatible with newer version(s) of modified hybrid devices 101. It is an object of this disclosure to recognize a modified smart device 101 having its software 708a utilize artificial intelligence models A, including future models A and future modified devices 101 which provide substantially similar operations.

With reference to all figures, it is recognized that in some embodiments, the original smart device 101A (for example, smart phone or tablet manufacturers) can, during the manufacturing stage (for example, for custom orders, or to be marketed as a different product or for a different application) directly manufacture the smart device 101A as a modified smart device 101. For example, the manufacturer can have a manufacturing option (either during the original manufacturing, or as part of a custom manufacturing/adapting process) in which the smart device 101 is directly manufactured without populating the battery 215A. It can also be that the smart device 101A manufactured can include a custom circuit 403A, either as an alternative module to the battery 215A, or directly embedded onto one of the device's electronic board(s) 203A, 205A. For example, the smart phone, smart tablet, or other type of smart device 101A manufacturer can have a template in which the device battery 215A is excluded (for example, by design, or simply not installed during manufacturing, or removed directly in a factory, distribution center or aftermarket center), thereby still leaving a space where the battery 215A was intended to be. It can also be that one, some, any or all of the battery replacement circuit components 403A, 404A, 305A, 405A are included (for example, by design, or simply installed during manufacturing as an alternative to a battery 215A, or added directly in a factory, distribution center or aftermarket center). It can also be that the device's 101 motherboard(s) 203A, interface(s) 204A, and/or daughterboard(s) 205A include a battery bypass circuit 403A (whether on board 203A, 204A, 205A, or through an additional one or more components 403A, 405A, 404A, 305A). It can also be that the device's software 708a can be directly loaded with alternative operating system software and/or booting sequence 500A, which can include already custom software 708a to perform hybrid device 101 functions which are typically different than those of a regular smart device 101A. It can also be that the modified device software 708a is already loading with AI software 905a such as specialized libraries and/or AI models A. It can also be the hybrid device 101 is packaged in different ways (for example, 700A, 7b-1, 7b-2, 7b-3, 7b-4, 7b-5, 7b-6, 7b-7, 7c-1, 7c-2, 7c-3, 7c-5, 7c-6, 7c-7, 7c-8, 7c-9).

For example, it can be (in some embodiments) that a smart device manufacturer (for example, a smart phone manufacturer or a tablet manufacturer) will modify a smart device 101A during the design, development and/or manufacturing phase to perform as a hybrid smart device 101. In such a case, the manufacturer can experience economies of scale in production, whereas the mobile electronics manufacturer can leverage a substantially similar production process for products which serve different needs. For example, unmodified smart devices 101A can perform as smart phones and tablets for consumer use. For example, modified smart device(s) 101 can be used as hybrid device(s) 101 which can also perform functions such as internet-of-things device(s), edge computing device(s), smart home device(s), tele-health terminal(s), digital signage unit(s), kiosk(s), sensor(s) (visual, audio, location, orientation, vibration, environmental, etc.), smart camera(s), automation controller(s), computer(s), image/video processor(s), digital agent(s), and/or other functions in which the computing infrastructure of the device 900 can perform different functions than those of a traditional device 101A, and in different environments. It is recognized that as of the date of filing, no smart device 101 manufacturer provides such custom manufacturing options (or aftermarket modifications), and this disclosure is intended to also cover embodiments where the smart device manufacturer directly manufactures hybrid devices 101, and/or employs such methods in its manufacturing process to provide alternative device 101 functions.

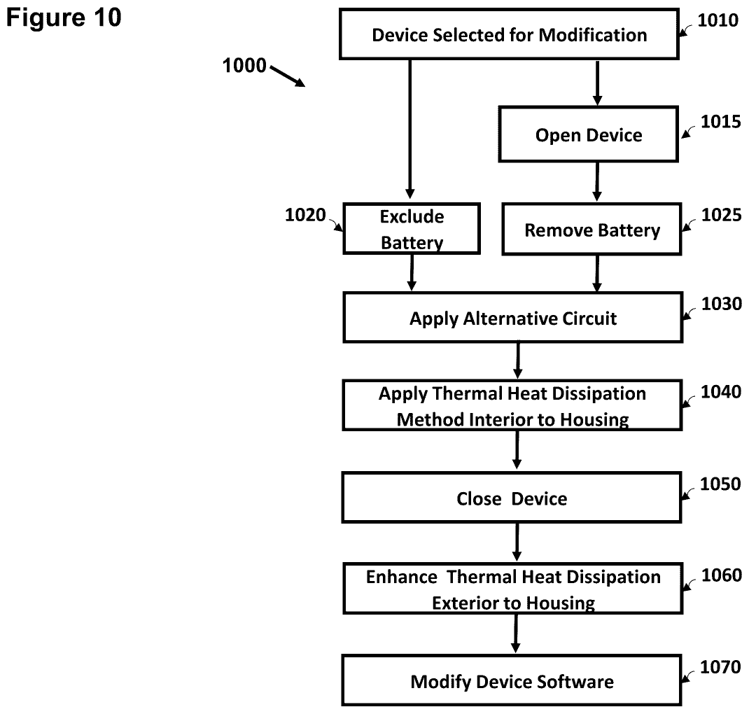

Referring to FIG. 10, there is depicted a sample method 1000 for modifying a smart phone or tablet device to a hybrid modified device. The original device can be selected 1010 during manufacturing (for example, when the device is being assembled), or after manufacturing (for example, after the device has already been assembled), for modification. In the event that the device is being manufactured, the battery can be excluded 1020 (as in, never populated). In the event that the device was already manufactured, the device needs to be opened 1015, and the battery needs to be removed 1025. Once the battery is removed 1025 or excluded 1020, an alternative circuit can be applied 1030, for example, automatically 1030 (i.e. the device motherboard or daughter board already has embedded alternative circuitry), by enabling alternative circuitry 1030 (for example, including or excluding a component on the device motherboard, switching on or off a component on the device motherboard, or connecting or disconnecting an item on the device motherboard), and/or by including alternative circuitry 1030 (for example, by adding a new custom circuit component). It is recognized that the alternative circuitry 1030 can include or exclude components in relation to simulating a button push for the device, if applicable and required by the device's circuitry software and/or firmware. The device can then be augmented with inclusion of heat dissipating materials at the interior of the device's housing 1040 (which can also displace air in some embodiments). Once the device battery is excluded, the device is able to boot on (electronically), heat dissipation methods are applied internally 1040 and the device can be closed 1050. It is recognized that during manufacturing other parts can also be assembled (not shown) or steps performed (not shown) which are anticipated in the assembly process of the device. It is also recognized that closing 1050 or opening 1050 the device can also include additional steps (e.g. application or softening of adhesives). Once the device is closed 1050, the device's exterior thermal dissipating properties can be enhanced 1060 through the passive and/or active use of material(s), attachment(s), enclosure(s) and/or fan(s), which increase thermal conductivity of the device's interior heat dissipating sources to an exterior medium. It can also include shielding the device from external heat generating sources (for example, the sun). The device software (which can include an operating system, application management software, applications, libraries, and/or AI models, and/or a combination thereof) can also be adapted 1070 to perform hybrid smart device functionality, for example through manual software change (e.g. through the device's USB port), or through over the air updates (for example, wireless, cellular, internet, LAN, etc.). It is further recognized that in different embodiments of the method some steps can be skipped, elaborated upon, shortened, and/or re-ordered.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases such as “one or more of” are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A modified smart device system, the system comprising:
a housing having an interior and an exterior;
a set of smart device components in the interior of the housing including a smart device memory, a smart device computing processor for executing a set of instructions stored on the smart device memory and a battery compartment adapted for holding a battery, such that the battery compartment is internal to the housing;
an alternative circuitry in substitution of the battery such that the battery is absent from the set of smart device components, the alternative circuitry installed in the housing and configured to supply operating power to the smart device motherboard instead of a battery; and
a thermally conductive material at least partially filling the battery compartment to promote heat dissipation.

2. The modified smart device system of claim 1, wherein the set of smart device components in the interior of the housing comprises: one or more camera(s); one or more graphic processing unit(s); and/or one or more artificial intelligence processor(s) capable of performing artificial intelligence processing tasks.

3. The modified smart device of claim 2, wherein the set of instructions comprise an application executable by the smart device computing processor, and wherein the set of instructions comprise image processing using artificial intelligence.

4. The modified smart device of claim 3, wherein the application when executed causes the smart device computing processor to analyze the digital images captured by the camera using artificial intelligence and to generate digital data for sending to a remote server when connectivity allows over a communication network.

5. The modified smart device of claim 1 further comprising the alternative circuitry as a custom power circuit in the housing, the custom power circuit replacing the battery of the smart device by connecting at least some of the set of smart device components to a power supply positioned external to the housing.

6. The modified smart device of claim 5 wherein the custom power circuit as a smart device battery replacement circuit includes one or more component(s) selected from the group consisting of: (a) an electrical safety component; (b) a voltage regulation component; (c) a capacitance component; (d) a reverse current protection component; (e) a temperature sensor; (f) a microcontroller; and (g) an inductance component.

7. The modified smart device of claim 5, further comprising the custom power circuit electrically connected to a power button of the set of smart device components, such that an electrical signal from the custom power circuit simulates a smart phone power button activation action.

8. The modified smart device of claim 5 further comprising a layer of thermally conductive material laid internally within the housing between a back plate of the housing and housed components of the set of smart device components.

9. The modified smart device of claim 8 further comprising a heat sink coupled to the housing.

10. The modified smart device of claim 9, wherein the set of smart device components included in the housing are further encompassed in an enclosure or case with accommodation for the heat sink.

11. The modified smart device of claim 10, wherein the smart device enclosure comprises a hood.

12. The modified smart device of claim 10, further comprising a mount which provides one or more degree(s) of articulation affixed to the smart device enclosure, wherein the mount permit the smart device to be affixed to a surface.

13. The modified smart device of claim 8, wherein the back plate is a custom back plate with a built-in heat dissipating configuration and materials.

14. The modified smart device of claim 1, wherein the set of instructions comprise an application executable by the smart device computing processor, wherein a device operating system stored in the memory is a modified operating system and the device operating system is programmed to launch the application automatically when the set of smart device components is booted, such that powering on the set of smart device components can take place without the use of a power button of the set of smart device components.

15. The modified smart device of claim 5, wherein the custom power circuit resides outside of the housing.

16. The modified smart device of claim 1, wherein the set of instructions comprise an application executable by the smart device computing processor, and wherein the application is launched automatically through an operating system setting upon a device boot of the set of smart device components.

17. The modified smart device of claim 1, wherein the set of instructions comprise an application executable by the smart device computing processor, and wherein the application is launched automatically when the modified device is switched from a booted state to an unlocked state.

18. The modified smart device of claim 1, wherein the set of instructions comprise an application executable by the smart device computing processor, and wherein the application is launched through a third party mobile device management application.

19. The modified smart device of claim 1, wherein the set of instructions comprise an application executable by the smart device computing processor, wherein the smart device further comprises a smart device display, and wherein the application when executed displays information on the smart device display.

20. The modified smart device of claim 8, wherein the smart device housing is further encompassed in a heat dissipating enclosure, and the enclosure supports a connection to power and/or communications.
